(19) United States
(12) Patent Application Publication
(10) Pub. No.: US 2022/0075507 A1
(43) Pub. Date: Mar. 10, 2022

(54) METHOD AND DEVICE FOR CONTROLLING REMOTELY CONTROLLED MOBILE PLATFORM, AND READABLE STORAGE MEDIUM

(71) Applicant: SZ DJI TECHNOLOGY CO., LTD., Shenzhen (CN)

(72) Inventors: Haoyu LI, Shenzhen (CN); Junfeng WU, Shenzhen (CN); Weixing ZHANG, Shenzhen (CN); Yana GUO, Shenzhen (CN); Zeyang FAN, Shenzhen (CN)

(73) Assignee: SZ DJI TECHNOLOGY CO., LTD., Shenzhen (CN)

(21) Appl. No.: 17/525,902

(22) Filed: Nov. 13, 2021

Related U.S. Application Data
(63) Continuation of application No. PCT/CN2019/087059, filed on May 15, 2019.

(51) Int. Cl. G06F 3/0481; G06F 3/0484; A63F 13/803; A63F 13/837; G05D 1/00

(52) U.S. Cl. CPC G06F 3/04817; G06F 3/04845; A63F 13/803; G05D 2201/0209; G05D 1/0016; G05D 1/0094; A63F 13/837

(57) ABSTRACT

A method and a device for controlling a remotely controlled mobile platform and a readable storage medium are provided. The method includes: displaying at least one function icon and at least one control icon, where the function icon represents a control program for implementing a preset function, and the control icon is used to control a control terminal and/or a remotely controlled mobile platform to execute the control program; generating, based on a selection operation of a user on the function icon, the control program associated with the selected function icon; and controlling, based on an operation of the user on the control icon, the control terminal and/or the remotely controlled mobile platform to execute the control program.

### RELATED APPLICATIONS

This application is a continuation application of PCT application No. PCT/CN2019/087059, filed on May 15, 2019, and the content of which is incorporated herein by reference in its entirety.

### TECHNICAL FIELD

Embodiments of the present disclosure relate to the technical field of man-machine interactions, and in particular, to a method and a device for controlling a remotely controlled mobile platform, and a readable storage medium.

### BACKGROUND

Scratch is a programming tool. Commands and parameters represented in forms of blocks and constituting a program are provided in Scratch. A user may perform programming according to a requirement by combining the blocks.

Being easy to operate, Scratch has been widely applied in a plurality of fields. For example, programming may be performed through Scratch, running steps of a program may be displayed on a display interface, and an intelligent device may be controlled by using the program.

However, in an existing solution to controlling a remotely controlled mobile platform by using a control program based on Scratch, the remotely controlled mobile platform may be controlled to perform only operations such as moving and simple shooting. Therefore, functions that may be implemented are usually limited. In an actual application, when the remotely controlled mobile platform is controlled to play a game by using a control program based on Scratch, since the functions that can be implemented are very limited, a battle process in the game is boring to a user, and user experience is poor.

### BRIEF SUMMARY

Embodiments of the present disclosure provide a method and a device for controlling a remotely controlled mobile platform, and a readable storage medium to resolve a technical problem that user experience is poor since functions that can be implemented in an existing method for controlling a remotely controlled mobile platform are limited.

According to a first aspect, some exemplary embodiments of the present disclosure provide a method for controlling a remotely controlled mobile platform, including: displaying at least one function icon, the at least one function icon being associated with at least one corresponding control program configured to control a target device to implement at least one preset function; displaying at least one control icon, the at least one icon being configured to control the target device to execute the at least one control program, where the target device includes at least one of the remotely controlled mobile platform or a control terminal in communication with the remotely controlled mobile platform; obtaining, from a user, a selection operation to a selected function icon of the at least one function icon; generating, based on the selection operation, the corresponding control program associated with the selected function icon; obtaining an operation from the user to an operated control icon of the at least one control icon; and controlling, based on the operation on the operated control icon, the target device to execute the control program associated with the selected function icon to implement the corresponding preset function, where the preset function includes controlling the target device to perform: recognizing and determining that the captured information includes identification information, where the captured information includes at least one of captured image information or captured sound information, obtaining a function corresponding to the identification information, and controlling, based on the identification information, the target device to implement the function corresponding to the identification information.

According to a second aspect, some exemplary embodiments of the present disclosure provide a method for controlling a remotely controlled mobile platform, including: obtaining a control instruction sent by a control terminal in communication with the remotely controlled mobile platform, where the control instruction includes a control program for controlling the target device in communication with the remotely controlled mobile platform to implement a preset function that includes: controlling the target device to perform: recognizing and determining that the captured information includes identification information, where the captured information includes at least one of captured image information or captured sound information, obtaining a function corresponding to the identification information, and controlling, based on the identification information, the target device to implement the function corresponding to the identification information; and executing the control instruction.

According to a third aspect, some exemplary embodiments of the present disclosure provide a remotely controlled mobile platform, including: at least one storage medium storing a set of instructions for controlling the remotely controlled mobile platform; and at least one processor in communication with the at least one storage medium, where during operation, the at least one processor executes the set of instructions to: obtain a control instruction sent by a control terminal in communication with the remotely controlled mobile platform, where the control instruction includes a control program for controlling the target device in communication with the remotely controlled mobile platform to implement a preset function that includes: controlling the target device to perform: recognizing and determining that the captured information includes identification information, where the captured information includes at least one of captured image information or captured sound information, obtaining a function corresponding to the identification information, and controlling, based on the identification information, the target device to implement the function corresponding to the identification information; and executing the control instruction.

According to the method for controlling a remotely controlled mobile platform, the device, and the readable storage medium provided in some exemplary embodiments, the at least one function icon and at least one control icon are displayed on the display interface of the control terminal; the selection operation of the user on the function icon is obtained, and the control program represented by the selected function icon is generated based on the selection operation; and the operation of the user on the control icon is obtained, and the control terminal and/or the remotely controlled mobile platform are/is controlled based on the operation on the control icon to execute the control program represented by the selected function icon, to implement the preset function, where the preset function that the function icon is used to implement includes: controlling the remotely controlled mobile platform and/or the control terminal to recognize the captured image/sound information to determine whether the image/sound information includes the identification information and if it is determined that the image/sound information includes the identification information, obtain the function corresponding to the identification information, and controlling, based on the identification information, the control terminal and/or the mobile platform to implement the function corresponding to the identification information. In this way, diversified control can be implemented on the remotely controlled mobile platform, and further, the user's game experience can be improved.

### BRIEF DESCRIPTION OF THE DRAWINGS

To describe the technical solutions in some exemplary embodiments of the present disclosure, the following briefly describes the accompanying drawings required for describing the embodiments. Apparently, the accompanying drawings in the following description show some exemplary embodiments of the present disclosure, and persons of ordinary skill in the art may still derive other drawings from these accompanying drawings without creative efforts.

FIG. 1 is a diagram of a network structure on which the present disclosure is based;

FIG. 2 is a schematic flowchart of a method for controlling a remotely controlled mobile platform according to some exemplary embodiments of the present disclosure;

FIG. 3 is a schematic diagram of a display interface according to some exemplary embodiments of the present disclosure;

FIG. 4 is a schematic flowchart of a method for controlling a remotely controlled mobile platform according to some exemplary embodiments of the present disclosure;

FIG. 5 is a schematic diagram of a display interface according to some exemplary embodiments of the present disclosure;

FIG. 6 is a schematic diagram of a display interface according to some exemplary embodiments of the present disclosure;

FIG. 7 is a schematic flowchart of a method for controlling a remotely controlled mobile platform according to some exemplary embodiments of the present disclosure;

FIG. 8 is a schematic diagram of a display interface according to some exemplary embodiments of the present disclosure;

FIG. 9 is a schematic diagram of a display interface according to some exemplary embodiments of the present disclosure;

FIG. 10 is a schematic diagram of a display interface according to some exemplary embodiments of the present disclosure;

FIG. 11 is a schematic diagram of a display interface according to some exemplary embodiments of the present disclosure;

FIG. 12 is a schematic flowchart of a method for controlling a remotely controlled mobile platform according to some exemplary embodiments of the present disclosure;

FIG. 13 is a schematic flowchart of a method for controlling a remotely controlled mobile platform according to some exemplary embodiments of the present disclosure;

FIG. 14 is a schematic flowchart of a method for controlling a remotely controlled mobile platform according to some exemplary embodiments of the present disclosure;

FIG. 15 is a diagram of extraction of a target region according to some exemplary embodiments of the present disclosure;

FIG. 16 is a schematic flowchart of a method for controlling a remotely controlled mobile platform according to some exemplary embodiments of the present disclosure;

FIG. 17 is a schematic flowchart of a method for controlling a remotely controlled mobile platform according to some exemplary embodiments of the present disclosure;

FIG. 18 is a schematic flowchart of a method for controlling a remotely controlled mobile platform according to some exemplary embodiments of the present disclosure;

FIG. 19 is a schematic structural diagram of a control terminal according to some exemplary embodiments of the present disclosure; and

FIG. 20 is a schematic structural diagram of a remotely controlled mobile platform according to some exemplary embodiments of the present disclosure.

### DETAILED DESCRIPTION

The following describes the technical solutions in some exemplary embodiments of the present disclosure with reference to the accompanying drawings. Apparently, the described exemplary embodiments are merely some but not all of the embodiments of the present disclosure. All other embodiments obtained by persons of ordinary skill in the art based on these exemplary embodiments of the present disclosure without creative efforts shall fall within the scope of protection of the present disclosure.

It should be noted that when a component is described as “fixed” to another component, the component may be directly located on another component, or an intermediate component may exist therebetween. When a component is considered as “connected” to another component, the component may be directly connected to another element, or an intermediate element may exist therebetween.

Unless otherwise defined, meanings of all technical and scientific terms used herein are the same as those generally understood by persons skilled in the art. The terms used herein are only to describe some exemplary embodiments, and not intended to limit the present disclosure. The term “and/or” used herein includes any and all possible combinations of one or more related items listed.

The following describes in detail some exemplary embodiments of the present disclosure with reference to the accompanying drawings. In absence of conflicts, the following exemplary embodiments and features thereof may be combined.

To resolve the technical problem that user experience is poor because functions that can be implemented in an existing method for controlling a remotely controlled mobile platform are limited, the present disclosure provides a method and a device for controlling a remotely controlled mobile platform, and a readable storage medium. It should be noted that the method and device for controlling a remotely controlled mobile platform, and the readable storage medium provided by the present disclosure can be applied to any scenario of controlling a mobile platform.

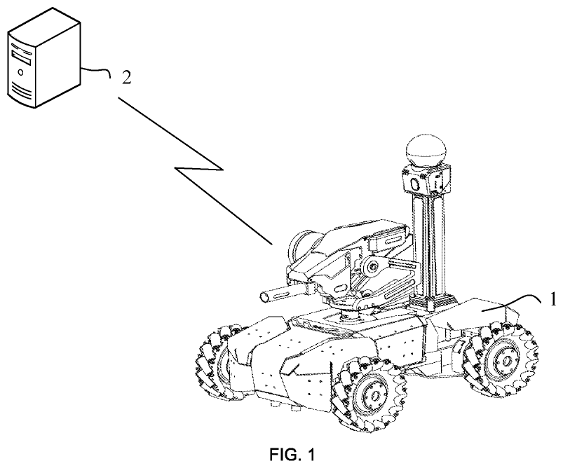

FIG. 1 is a diagram of a network structure on which the present disclosure is based. As shown in FIG. 1, the network architecture on which the present disclosure is based may include at least a remotely controlled mobile platform 1 and a control terminal 2, where the remotely controlled mobile platform 1 is in communication with the control terminal 2, and may further exchange information with the control terminal 2. The remotely controlled mobile platform 1 includes but is not limited to a mobile vehicle, an unmanned aerial vehicle, a mobile robot, and the like. The control terminal 2 includes but is not limited to a mobile terminal, a computer, and the like.

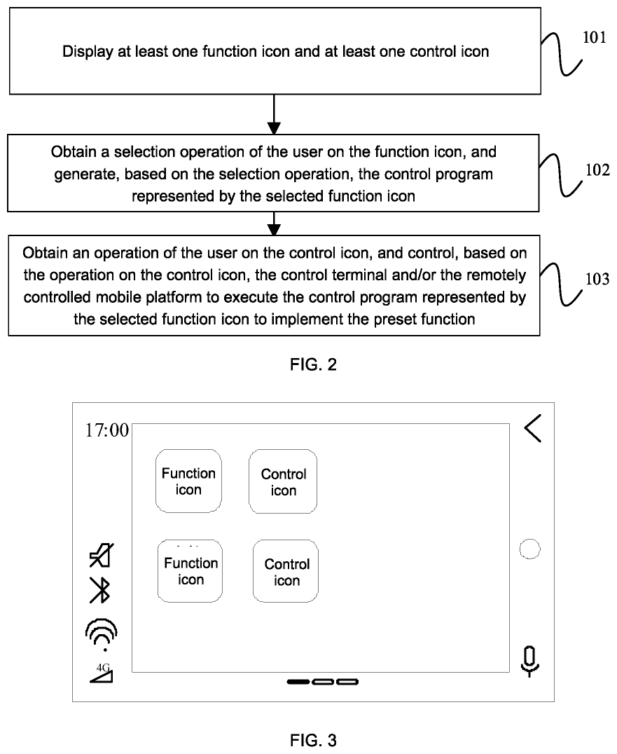

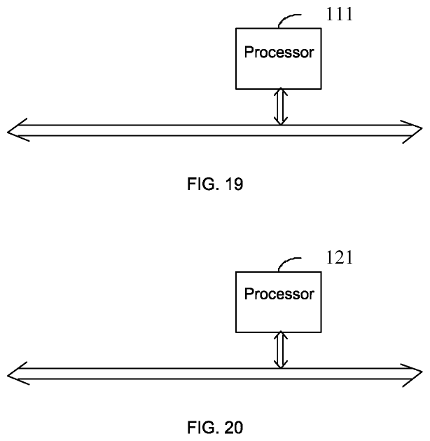

FIG. 2 is a schematic flowchart of a method for controlling a remotely controlled mobile platform according to some exemplary embodiments of the present disclosure. FIG. 3 is a schematic diagram of a display interface according to some exemplary embodiments of the present disclosure. The method may be applied to a control terminal, where the control terminal may be configured to establish a communication with the remotely controlled mobile platform. The method may be executed by a control terminal as shown in FIG. 19 and a remotely controlled mobile platform as shown in FIG. 20 of the present disclosure. For example, the method may be stored as a set of instructions in a storage medium of the control terminal and/or the remotely controlled mobile platform. A processor(s) of the control terminal and/or the remotely controlled mobile platform may, during operation, read and execute the set of instructions to perform the following steps of the method. As shown in FIG. 2, the method may include the following steps.

Step 101: Display at least one function icon and at least one control icon, where the function icon is used to represent a control program for controlling the control terminal and/or the mobile platform to implement a preset function, and the control icon is used to control the control terminal and/or the remotely controlled mobile platform to execute the control program.

Some exemplary embodiments may be performed by the control terminal. To enable a user to control the remotely controlled mobile platform, icons may be displayed on a display interface of the control terminal, where the icons may specifically include a function icon and a control icon. The function icon may be used to represent a control program for controlling the remotely controlled mobile platform to implement a preset function. There may be at least one function icon, and each function icon may represent a different function component. In addition, the control icon may also be provided on the display interface, and the control icon may be used to control the remotely controlled mobile platform to execute the control program identified by the function icon. Correspondingly, after the control icon is triggered by a user, the remotely controlled mobile platform may obtain and execute the control program. The remotely controlled mobile platform may move during execution of the control program. The remotely controlled mobile platform may further carry an image capture device, where the image capture device may perform operations such as image shooting. The remotely controlled mobile platform may further carry a sound capture device, where the sound capture device may perform operations such as obtaining external sounds.

Step 102: Obtain a selection operation of the user on the function icon, and generate, based on the selection operation, the control program represented by the selected function icon.

In some exemplary embodiments, to obtain the control program, the user may perform the selection operation on the function icon based on a current requirement, so that the control program represented by the function icon may be generated based on the selection operation to facilitate calling the control program by the user.

Specifically, the control program represented by the function icon may include a function component (herein the function component is a part of the control program which is embodied as a corresponding icon visible to a user and controllable by a user, in other words, in the description, the term “function component” refer to both a functional part of the control program and an icon associated with this functional part), where the function component may include at least one of the following: a visual recognition component, a clapping sound recognition component, and a patrol line recognition component.

The user may select, based on the current requirement, a function component to be used, and generate a corresponding control program based on the selected function component.

Step 103: Obtain an operation of the user on the control icon, and control, based on the operation on the control icon, the control terminal and/or the remotely controlled mobile platform to execute the control program represented by the selected function icon to implement the preset function, where the preset function that the function icon is used to implement may include: controlling the remotely controlled mobile platform and/or the control terminal to recognize captured image/sound information to determine whether the image/sound information includes identification information and if it is determined that the image/sound information includes the identification information, obtain a function corresponding to the identification information, and controlling, based on the identification information, the control terminal and/or the mobile platform to implement the function corresponding to the identification information.

In some exemplary embodiments, after the control program corresponding to the function icon is obtained based on the selection operation of the user, the operation of the user on the control icon may be obtained, and based on the operation of the user on the control icon, the control terminal and/or the remotely controlled mobile platform are/is controlled to execute the control program represented by the selected function icon, to implement the preset function. Specifically, the preset function may include: obtaining image/sound information captured by the remotely controlled mobile platform; controlling the remotely controlled mobile platform and/or the control terminal to recognize the image/sound information to obtain a recognition result and determine whether the recognition result includes preset identification information and if it is detected that the recognition result includes the preset identification information, determining a function corresponding to the identification information; and controlling, based on the identification information, the remotely controlled mobile platform and/or the control terminal to execute the function corresponding to the identification information. It should be noted that the process of recognizing the image/sound and determining the function corresponding to the identification information may be performed by the control terminal, or may be performed by the mobile platform. Assuming that the control terminal performs the recognition operation, after obtaining the image/sound information, the remotely controlled mobile platform may transmit the image/sound information to the control terminal; and the control terminal may recognize the image/sound information according to a preset recognition method, determine whether the image/sound information includes the preset identification information, and if the preset identification information exists, may determine the function corresponding to the identification information, and control the remotely controlled mobile platform to perform the function. For example, in the case where the remotely controlled mobile platform performs the recognition operation, after obtaining the image/sound information, the remotely controlled mobile platform may recognize the image/sound information to determine whether the image/sound information includes the preset identification information, and if the preset identification information exists, may determine the function corresponding to the identification information, and send, to the control terminal, the function corresponding to the identification information, so that the control terminal may control the remotely controlled mobile platform to perform the function.

Specifically, the identification information may include at least one of the following: a clapping sound, a patrol line marker, or a picture marker.

The identification information may be specifically a clapping sound, a patrol line marker, or a picture marker. It should be noted that different quantities of claps, different patrol line markers, and different picture markers may correspond to different functions. For example, when the identification information is a clapping sound, a function corresponding to two claps may be controlling the remotely controlled mobile platform to move in a direction; and a function corresponding to three claps may be controlling the remotely controlled mobile platform to photograph a current scene.

It should be noted that, to control the remotely controlled mobile platform to perform more functions, a plurality of character pictures may be preset, and characters in the character pictures may correspond to different functions. To enable the remotely controlled mobile platform to perform the corresponding functions based on the character pictures, a preset functional function may be trained based on the characters in the character pictures to obtain a visual recognition component. Because the character pictures are light-weighted, the character pictures can be carried to any game scenes. Further, game battle scenes based on character recognition are also rich. Therefore, on a basis of improving diversity of battle functions, an effect of diversifying battle scenes can be achieved, and user experience is further improved. In addition, to enable the remotely controlled mobile platform and/or the control terminal to quickly recognize the characters, the characters in the character pictures may be characters that undergo pixel art processing.

According to the method for controlling a remotely controlled mobile platform provided in some exemplary embodiments, the at least one function icon and at least one control icon may be displayed on the display interface of the control terminal; the selection operation of the user on the function icon may be obtained, and the control program represented by the selected function icon may be generated based on the selection operation; and the operation of the user on the control icon is obtained, and the control terminal and/or the remotely controlled mobile platform are/is controlled based on the operation on the control icon to execute the control program represented by the selected function icon, so as to implement the preset function, where the preset function that the function icon is used to implement may include: controlling the remotely controlled mobile platform and/or the control terminal to recognize the captured image/sound information to determine whether the image/sound information includes the identification information, and if it is determined that the image/sound information includes the identification information, obtain the function corresponding to the identification information, and controlling, based on the identification information, the control terminal and/or the mobile platform to implement the function corresponding to the identification information. In this way, diversified control can be implemented on the remotely controlled mobile platform, and further, the user's game experience can be improved.

Further, on a basis of any one of the foregoing exemplary embodiments, the recognizing of the captured image/sound information to determine whether the image/sound information includes the identification information may include:

processing the captured image/sound information to generate processed information, and determining, based on the processed information, whether the image/sound information includes the identification information.

In some exemplary embodiments, in order to obtain the identification information corresponding to the image/sound information, the captured image/sound may be processed to generate the processed information, and then whether the image/sound information includes the identification information may be determined based on the processed information. It should be noted that any algorithm that can perform image recognition or sound recognition may be used herein to process the image/sound information. This is not limited in the present disclosure.

Specifically, on a basis of any one of the foregoing exemplary embodiments, the recognizing of the captured image/sound information to determine whether the image/sound information includes the identification information may include: controlling a hardware device provided on the remotely controlled mobile platform to process the image/sound information to generate the processed information, and determine, based on the processed information, whether the image/sound information includes the identification information; or

controlling the control terminal to obtain the captured image/sound information, process the image/sound information to generate the processed information, and determine, based on the processed information, whether the image/sound information includes the identification information.

In some exemplary embodiments, the process of recognizing the image/sound and determining the function corresponding to the identification information may be performed by the control terminal, or may be performed by the mobile platform. Assuming that the control terminal performs the recognition operation, after obtaining the image/sound information, the remotely controlled mobile platform may transmit the image/sound information to the control terminal; and then the control terminal recognizes the image/sound information according to a preset recognition method and determines whether the image/sound information includes the preset identification information; if the preset identification information exists, it may determine the function corresponding to the identification information, and control the remotely controlled mobile platform to perform the function. Alternatively, assuming that the remotely controlled mobile platform performs the recognition operation, after obtaining the image/sound information, the remotely controlled mobile platform may recognize the image/sound information to determine whether the image/sound information includes the preset identification information, and if the preset identification information exists, it may determine the function corresponding to the identification information, and then send, to the control terminal, the function corresponding to the identification information, so that the control terminal may control the remotely controlled mobile platform to perform the function.

According to the method for controlling a remotely controlled mobile platform provided in some exemplary embodiments, the captured image/sound information may be processed to generate the processed information, and whether the image/sound information includes the identification information may be determined based on the processed information. In this way, diversified control can be implemented on the remotely controlled mobile platform by using the identification information, and further, the user's game experience can be improved.

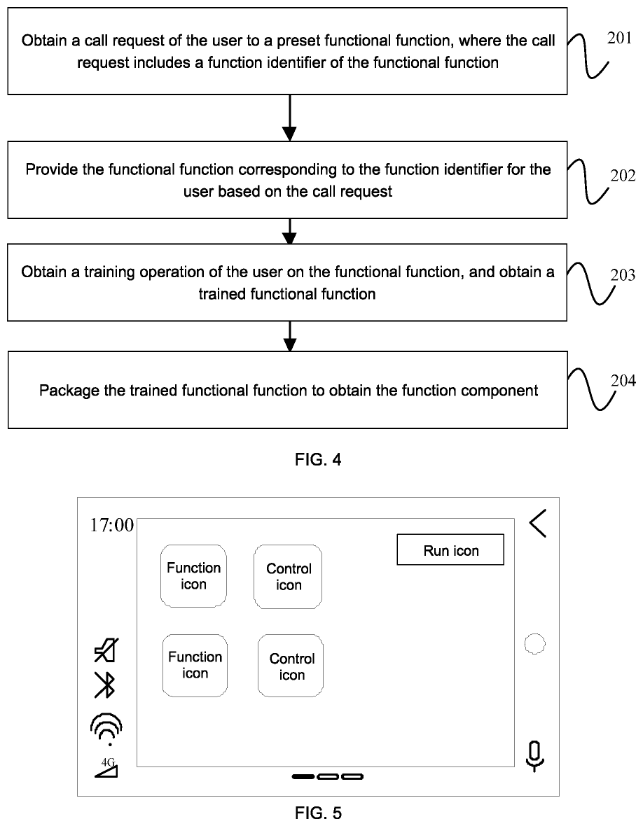

FIG. 4 is a schematic flowchart of a method for controlling a remotely controlled mobile platform according to some exemplary embodiments of the present disclosure. On a basis of any one of the foregoing exemplary embodiments, before displaying the at least one function icon and at least one control icon, the method may further include:

Step 201: Obtain a call request of the user to a preset functional function, where the call request includes a function identifier of the functional function.

Step 202: Provide the functional function corresponding to the function identifier for the user based on the call request.

Step 203: Obtain a training operation of the user on the functional function, and obtain a trained functional function.

Step 204: Package the trained functional function to obtain the function component.

In some exemplary embodiments, to implement diversified control on the remotely controlled mobile platform, at least one functional function that can implement the preset function may be pre-trained, and the functional function may be packaged into the function component, so that the user can directly call the function component for use. Therefore, on a basis of implementing diversified control on the remotely controlled mobile platform, efficiency of generating the control program may be improved. Specifically, the call request of the user to the preset functional function may be obtained, where the call request may include the function identifier of the functional function. There may be one or more functional functions. When there is one functional function, the functional function may be trained by using different data, so that a trained functional function can implement different functions. In some exemplary embodiments, when there are a plurality of functional functions, each functional function may be trained by using different data, and a plurality of trained functional functions that can implement different functions are thus obtained. Further, after the call request of the user is obtained, the functional function corresponding to the function identifier may be obtained based on the call request and the user may train the functional function to obtain the trained functional function. The trained functional function is then packaged to obtain the function component that can implement the preset function, so as to facilitate calling by the user, and increase functionality and fun of the interactive interface.

According to the method for controlling a remotely controlled mobile platform provided in some exemplary embodiments, the functional function may be pre-trained to obtain the trained functional function that may implement the preset function; and the functional function may be packaged to obtain the function component that may be called conveniently. Therefore, on a basis of implementing diversified control on the remotely controlled mobile platform, efficiency of generating the control program may be improved.

Specifically, on a basis of any one of the foregoing exemplary embodiments, the obtaining of the training operation of the user on the functional function, and the obtaining of the trained functional function may include:

obtaining preset first training data, where the first training data includes audio data of different quantities of claps in different scenarios; and

training the functional function by using the first training data to obtain a trained clapping sound recognition function; and

correspondingly, the packaging of the trained functional function to obtain the function component may include:

packaging the trained clapping sound recognition function to obtain a clapping sound recognition component.

In some exemplary embodiments, to obtain the clapping sound recognition component, first, it is necessary to obtain the preset first training data, where the first training data may include the audio data of different quantities of claps in different scenarios. Specifically, the first training data may include clapping sound information formed by one clap and two claps. To improve recognition accuracy of the trained functional function, the first training data may further include the audio data of claps in different scenarios. Further, the functional function may be trained by using the preset first training data, to obtain the trained clapping sound recognition function. For example, the preset functional function may be a neural network algorithm. For each piece of clapping sound audio data, a quantity of claps generating the audio data may be determined, and data annotation may be performed on the audio data based on the quantity of claps. The neural network algorithm may be trained by using the annotated audio data to obtain the trained clapping sound recognition function. Therefore, accuracy of clapping sound recognition is improved. To enable the user to call the clapping sound recognition algorithm more conveniently, the clapping sound recognition algorithm may be packaged to obtain the clapping sound recognition component, so as to facilitate calling by the user and increase functionality and fun of the interactive interface.

According to the method for controlling a remotely controlled mobile platform provided in some exemplary embodiments, the preset first training data may be obtained, where the first training data may include the audio data of different quantities of claps in different scenarios; the functional function is then trained by using the first training data to obtain the trained clapping sound recognition function; and the trained clapping sound recognition function may be packaged to obtain the clapping sound recognition component. Therefore, on a basis of implementing diversified control on the remotely controlled mobile platform, efficiency of generating the control program can be improved.

Specifically, on a basis of any one of the foregoing exemplary embodiments, the obtaining of the training operation of the user on the functional function, and obtaining of the trained functional function may include:

obtaining preset second training data, where the second training data includes at least one of the following: a character and image data, and the character includes a letter, a number, and a special symbol; and

training the functional function by using the second training data to obtain a trained visual recognition function; and

correspondingly, the packaging of the trained functional function to obtain the function component may include:

packaging the trained visual recognition function to obtain the visual recognition component.

In some exemplary embodiments, to obtain the visual recognition component, first, it is necessary to obtain the preset second training data, where the second training data may include the character and image data, and the character includes but is not limited to the letter, number, and special symbol. To enable the preset functional function to implement the preset function, the functional function may be trained by using the second training data to obtain the trained visual recognition function.

Specifically, on a basis of any one of the foregoing exemplary embodiments, the training of the functional function by using the second training data to obtain the trained visual recognition function may include:

storing the second training data as a standard image to obtain the trained visual recognition function.

In some exemplary embodiments, specifically, the second training data may be used as a standard image to obtain the trained visual recognition function. Therefore, after the image information captured by the remotely controlled mobile platform is obtained subsequently, the image information may be directly compared with the preset standard image. If a similarity therebetween exceeds a preset threshold, it may be determined that the image information includes the preset identification information. In this way, whether the identification information is preset in the image information is determined.

To enable the user to call the visual recognition function more conveniently, the visual recognition algorithm may be packaged to obtain the visual recognition component.

According to the method for controlling a remotely controlled mobile platform provided in some exemplary embodiments, the preset second training data is obtained, where the second training data may include at least one of the following: the character and image data, and the character may include the letter, number, and special symbol; the functional function is trained by using the second training data to obtain the trained visual recognition function; and the trained visual recognition function is packaged to obtain the visual recognition component. Therefore, on a basis of implementing diversified control on the remotely controlled mobile platform, efficiency of generating the control program can be improved.

Specifically, on a basis of any one of the foregoing exemplary embodiments, the obtaining of the training operation of the user on the functional function and the obtaining of the trained functional function may include:

obtaining preset third training data, where the third training data includes patrol line image data, and the remotely controlled mobile platform can move according to the patrol line; and

training the trained visual recognition function by using the third training data to obtain a trained patrol line recognition function; and

correspondingly, the packaging of the trained functional function to obtain the function component may include:

packaging the trained patrol line recognition function to obtain the patrol line recognition component.

In some exemplary embodiments, to obtain the patrol line recognition component, first, it is necessary to obtain the third training data, where the third training data may include the patrol line mage data, and the patrol line image data may include training data of different directions and different colors, and the remotely controlled mobile platform may move based on the training data. Further, the functional function may be trained by using the third training data to obtain the trained patrol line recognition function. To enable the user to call the patrol line recognition function more conveniently, the patrol line recognition algorithm may be packaged to obtain the patrol line recognition component.

According to the method for controlling a remotely controlled mobile platform provided in some exemplary embodiments, the preset third training data is obtained, where the third training data may include the patrol line image data, and the remotely controlled mobile platform may move according to the patrol line; the trained visual recognition function is trained by using the third training data to obtain the trained patrol line recognition function; and the trained patrol line recognition function is packaged to obtain the patrol line recognition component. Therefore, on a basis of implementing diversified control on the remotely controlled mobile platform, efficiency of generating the control program can be improved.

Further, on a basis of any one of the foregoing exemplary embodiments, prior to displaying the at least one function icon and the at least one control icon, the method may further include:

displaying at least one function category icon;

obtaining a trigger operation of the user on the function category icon; and

displaying the at least one function icon based on the trigger operation.

In some exemplary embodiments, to save the time for the user to select a function icon, function icons may be classified into at least one group by category, and all function icons in the group can be obtained by triggering the group. Specifically, the at least one function category icon may be provided on the display interface of the control terminal; when the trigger operation of the user on the function category icon is obtained; the at least one function icon is displayed on the display interface of the control terminal based on the trigger operation.

According to the method for controlling a remotely controlled mobile platform provided in some exemplary embodiments, the at least one function category icon may be displayed on the display interface of the control terminal; the trigger operation of the user on the function category icon may be obtained; and the at least one function icon may be displayed on the display interface of the control terminal based on the trigger operation. Therefore, on a basis of implementing diversified control on the remotely controlled mobile platform, the time required for the user to select the function icon is saved.

Further, on a basis of any one of the foregoing exemplary embodiments, the obtaining of the selection operation of the user on the function icon and the generating, based on the selection operation, of the control program represented by the selected function icon may include:

obtaining at least one selection operation of the user on the function icon; and

generating the control program according to an order of the at least one selection operation.

In some exemplary embodiments, one control program may include a plurality of program statements and/or function components. Therefore, to determine the order of the program statements and/or function components, at least one selection operation of the user on the function icon may be obtained to determine the function icon triggered by the user each time. The control program is generated according to the order of the trigger operations.

Correspondingly, on a basis of any one of the foregoing exemplary embodiments, the obtaining of the operation of the user on the control icon and the controlling, based on the operation on the control icon, of the control terminal and/or the remotely controlled mobile platform to execute the control program represented by the selected function icon to implement the preset function may include:

obtaining the operation of the user on the control icon; and

controlling, based on the operation of the user on the control icon, the control terminal and/or the remotely controlled mobile platform to execute, according to order of the function components in the control program represented by the function icon, the control program represented by the selected function icon to implement the preset function.

In some exemplary embodiments, to implement effective control on the remotely controlled mobile platform, after the operation of the user on the control icon is obtained, the remotely controlled mobile platform may be controlled, based on the operation of the user on the control icon, to execute the control program according to the order of the program statements and/or function components in the control program.

According to the method for controlling a remotely controlled mobile platform provided in some exemplary embodiments, the at least one selection operation of the user on the function icon may be obtained; and the control program may be generated according to the order of the selection operation. Therefore, the control program can be quickly generated, and the efficiency of controlling the remotely controlled mobile platform is improved.

FIG. 5 is a schematic diagram of a display interface according to some exemplary embodiments of the present disclosure. On a basis of any one of the foregoing exemplary embodiments, as shown in FIG. 5, the control icon may include a run icon; and the obtaining of the operation of the user on the control icon and the controlling, based on the operation on the control icon, of the control terminal and/or the remotely controlled mobile platform to execute the control program represented by the selected function icon to implement the preset function may include:

obtaining a run instruction generated by triggering the run icon by the user; and

controlling, based on the run instruction, the control terminal and/or the remotely controlled mobile platform to execute the control program represented by the selected function icon to implement the preset function.

In some exemplary embodiments, the control icon may specifically include the run icon. As shown in FIG. 5, the run icon may be provided on the display interface of the control terminal. To implement control on the control terminal and/or the remotely controlled mobile platform, the run instruction generated by triggering the run icon by the user may be obtained; and based on the run instruction, the control terminal and/or the remotely controlled mobile platform are/is controlled to execute the control program represented by the selected function icon to implement the preset function.

According to the method for controlling a remotely controlled mobile platform provided in some exemplary embodiments, the run instruction generated by triggering the run icon by the user is obtained; and based on the run instruction, the control terminal and/or the remotely controlled mobile platform are/is controlled to execute the control program represented by the selected function icon to implement the preset function. Therefore, fast control can be implemented on the control terminal and/or the remotely controlled mobile platform, and user experience is improved.

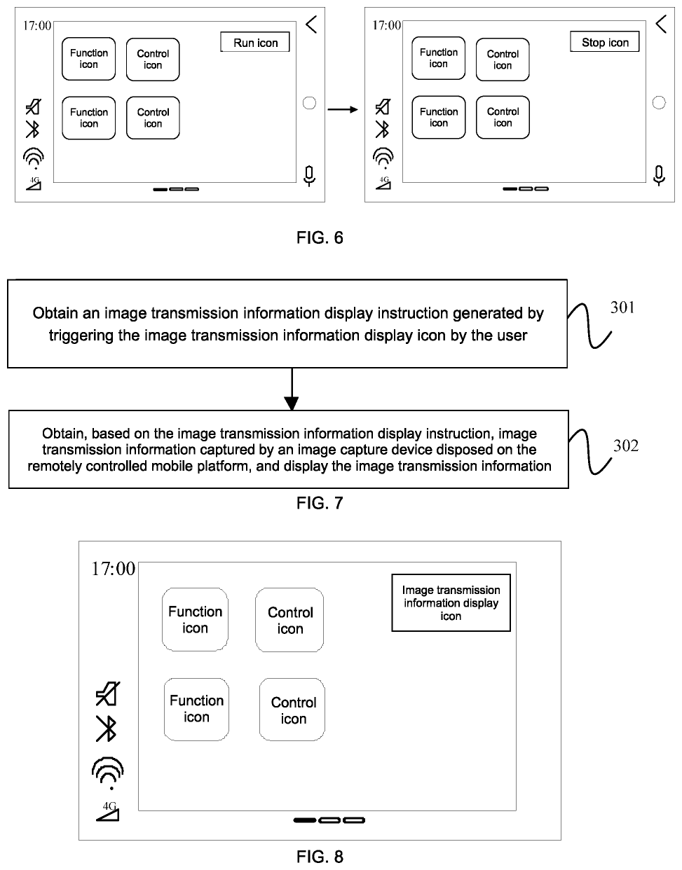

FIG. 6 is a schematic diagram of a display interface according to some exemplary embodiments of the present disclosure. On a basis of any one of the foregoing exemplary embodiments, after obtaining the run instruction generated by triggering the run icon by the user, the method may further include:

switching a running status of the run icon based on the trigger, where the running status includes a running state and a stopping state.

In some exemplary embodiments, to enable the user to learn a current running status of the control program, different running statuses may be set for the run icon, where the running status may specifically include the running state and the stopping state. The running status of the run icon may be switched based on the trigger of the user. In an actual application, an initial status of the run icon may be the running state. After a trigger of the user is obtained, the running state may be adjusted to the stopping state. Correspondingly, when the run icon is in the stopping state, after a trigger of the user is obtained, the stopping state may be adjusted to the running state.

According to the method for controlling a remotely controlled mobile platform provided in some exemplary embodiments, the running status of the run icon may be switched based on the trigger, where the running status may include the running state and the stopping state. Therefore, fast control may be implemented on the control terminal and/or the remotely controlled mobile platform, the user can learn the current running status of the control program, and user experience is further improved.

Further, on a basis of any one of the foregoing exemplary embodiments, the control icon may include a stop icon; and after obtaining the operation of the user on the control icon and controlling, based on the operation on the control icon, the control terminal and/or the remotely controlled mobile platform to execute the control program represented by the selected function icon to implement the preset function, the method may further include:

obtaining a stop instruction generated by triggering the stop icon by the user; and

controlling, based on the stop instruction, the control terminal and/or the remotely controlled mobile platform to stop executing the control program.

In some exemplary embodiments, the control program may specifically further include the stop icon, and the user may control, by triggering the stop icon, the control program to stop running. Specifically, the stop instruction generated by triggering the stop icon by the user may be obtained; and based on the stop instruction, the control terminal and/or the remotely controlled mobile platform are/is controlled to stop executing the control program.

Specifically, on a basis of any one of the foregoing exemplary embodiments, the stop icon may include a preset return icon and the run icon in the stopping state.

In some exemplary embodiments, the stop icon may be the preset return icon, or may be the run icon in the stopping state, and the user may control the control program by triggering the two stop icons. This is not limited in the present disclosure.

According to the method for controlling a remotely controlled mobile platform provided in some exemplary embodiments, the stop instruction generated by triggering the stop icon by the user is obtained; and based on the stop instruction, the control terminal and/or the remotely controlled mobile platform are/is controlled to stop executing the control program. Therefore, fast control can be implemented on the control terminal and/or the remotely controlled mobile platform, and user experience is improved.

FIG. 7 is a schematic flowchart of a method for controlling a remotely controlled mobile platform according to some exemplary embodiments of the present disclosure. FIG. 8 is a schematic diagram of a display interface according to some exemplary embodiments of the present disclosure. On a basis of any one of the foregoing exemplary embodiments, as shown in FIG. 7 and FIG. 8, the control icon may include an image-transmission-information-display icon; and after obtaining the operation of the user on the control icon and controlling, based on the operation on the control icon, the control terminal and/or the remotely controlled mobile platform to execute the control program represented by the selected function icon to implement the preset function, the method may further include:

Step 301: Obtain an image-transmission-information-display instruction generated by triggering the image-transmission-information-display icon by the user.

Step 302: Obtain, based on the image-transmission-information-display instruction, image transmission information captured by an image capture device disposed on the remotely controlled mobile platform, and display the image transmission information.

In some exemplary embodiments, the control terminal may control the image capture device disposed on the remotely controlled mobile platform to capture the image transmission information. In addition, the control terminal may further control whether to display the image transmission information on the display interface. Specifically, the control icon may include the image-transmission-information-display icon, and the image-transmission-information-display icon may be displayed on the display interface. Further, the image-transmission-information-display instruction generated by triggering the image-transmission-information-display icon by the user may be obtained; and based on the image-transmission-information-display instruction, the image transmission information captured by the image capture device disposed on the remotely controlled mobile platform may be obtained and displayed.

According to the method for controlling a remotely controlled mobile platform provided in some exemplary embodiments, the image-transmission-information-display instruction generated by triggering the image-transmission-information-display icon by the user is obtained; and based on the image-transmission-information-display instruction; the image transmission information captured by the image capture device disposed on the remotely controlled mobile platform is obtained and displayed. Therefore, whether to display the image transmission information on the display interface can be controlled, the user may independently decide whether to view the image transmission information, and user experience is improved.

Further, on a basis of any one of the foregoing exemplary embodiments, the control icon may further includes a programming-mode-switching icon; and the method may further include:

obtaining a programming-mode-switching instruction generated by triggering the programming-mode-switching icon by the user; and

calling a preset programming panel based on the programming-mode-switching instruction, so that the user may edit code on the programming panel to generate the control program.

In some exemplary embodiments, the control icon may specifically include the programming-mode-switching icon, and the user may switch a programming mode by triggering the programming-mode-switching icon. Specifically, the programming-mode-switching instruction generated by triggering the programming-mode-switching icon by the user may be obtained; and a preset programming panel may be called based on the programming-mode-switching instruction, so that the user can edit the control program by using the compiling panel. Based on an actual application distance, generally, at least one function icon may be provided on the display interface, each function icon may represent one program statement and/or function component, and the user may edit the control program by selecting the function icon. After triggering the programming-mode-switching icon to generate the programming-mode-switching instruction, the user may call the preset compiling panel based on the programming-mode-switching instruction, so that the user may edit the code on the programming panel based on a current requirement to obtain the control program.

According to the method for controlling a remotely controlled mobile platform provided in some exemplary embodiments, the programming-mode-switching instruction generated by triggering the programming-mode-switching icon by the user is obtained; and the preset programming panel is called based on the programming-mode-switching instruction, so that the user may edit the code on the programming panel to generate the control program. In this way, a plurality of manners is provided for the user to generate the control program, various requirements of the user on the programming mode are satisfied, and user experience is further improved.

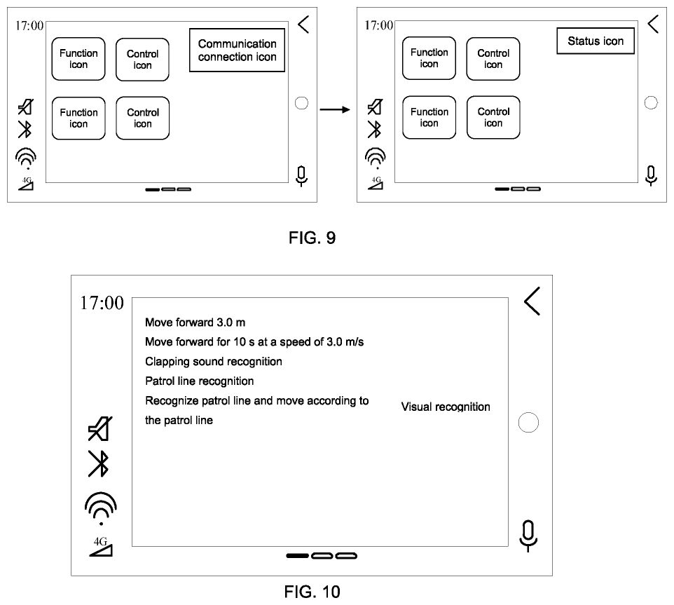

FIG. 9 is a schematic diagram of a display interface according to some exemplary embodiments of the present disclosure. On a basis of any one of the foregoing exemplary embodiments, as shown in FIG. 9, the control icon may further include a communication icon; and before obtaining an operation of the user on the control icon and controlling, based on the operation on the control icon, the control terminal and/or the remotely controlled mobile platform to execute the control program represented by the selected function icon to implement the preset function, the method may further include:

obtaining a connection instruction generated by triggering the communication icon by the user; and

establishing a communication to the remotely controlled mobile platform in a preset connection mode based on the connection instruction.

In some exemplary embodiments, to control the remotely controlled mobile platform, the control terminal first needs to establish the communication with the remotely controlled mobile platform. Specifically, the control icon further includes the communication establishment icon. After the connection instruction generated by triggering the communication establishment icon by the user is obtained, the communication may be established with the remotely controlled mobile platform in the preset connection mode based on the connection instruction. It should be noted that the control terminal may establish the communication with the remotely controlled mobile platform in any mode. This is not limited in the present disclosure. For example, a Wi-Fi connection, a Bluetooth connection, or a routing connection may be used.

According to the method for controlling a remotely controlled mobile platform provided in some exemplary embodiments, the connection instruction generated by triggering the communication icon by the user is obtained; and the communication is established to the remotely controlled mobile platform in the preset connection mode based on the connection instruction. Therefore, the control terminal can establish the communication with the remotely controlled mobile platform, and this provides a basis for subsequently controlling the remotely controlled mobile platform.

Further, on a basis of any one of the foregoing exemplary embodiments, after establishing the communication with the remotely controlled mobile platform in a preset connection mode based on the connection instruction, the method may further include:

switching the communication icon to a remotely controlled mobile platform status icon.

In some exemplary embodiments, to enable the user to learn a status of the remotely controlled mobile platform in time and determine whether a connection is currently established to the remotely controlled mobile platform, after the communication is established to the remotely controlled mobile platform in the preset connection mode based on the connection instruction, as shown in FIG. 9, the communication icon may be switched to the remotely controlled mobile platform status icon, where the status of the remotely controlled mobile platform may include a power level, a wireless identifier, or the like of the remotely controlled mobile platform.

According to the method for controlling a remotely controlled mobile platform provided in some exemplary embodiments, the communication icon is switched to the remotely controlled mobile platform status icon. Therefore, the user may learn the status of the remotely controlled mobile platform in time and may determine whether a communication is currently established to the remotely controlled mobile platform, and user experience is further improved.

FIG. 10 is a schematic diagram of a display interface according to some exemplary embodiments of the present disclosure. On a basis of any one of the foregoing exemplary embodiments, as shown in FIG. 10, after obtaining the selection operation of the user on the function icon and generating, based on the selection operation, the control program represented by the selected function icon, the method may further include:

obtaining a removal operation of the user on a function component in the control program; and

moving, based on the removal operation, the function component selected by the user to a preset area.

In some exemplary embodiments, after the user performs the selection operation on the function icon to generate the control program, the user may perform the removal operation on the function component in the control program based on a requirement. Specifically, the removal operation of the user on the function component in the control program may be obtained; and the function component selected by the user is moved to the preset area based on the removal operation. As shown in FIG. 10, the function component selected by the user may be recognized visual label information, and the function component may be moved to an area far away from the control program based on the removal operation of the user.

Specifically, the obtaining of the removal operation of the user on the control program may include:

obtaining the removal operation performed by the user on the function component by pressing and holding, and/or double-clicking, and/or dragging.

The user may specifically trigger the removal operation by pressing and holding, and/or double-clicking, and/or dragging. The foregoing operation can be conveniently performed to modify the control program, and the user does not need to recode the control program. Therefore, efficiency of compiling the control program can be improved.

According to the method for controlling a remotely controlled mobile platform provided in some exemplary embodiments, the removal operation of the user on the function component in the control program is obtained; and the function component selected by the user is moved to the preset area based on the removal operation. Therefore, efficiency of compiling the control program can be improved, and user experience is further improved.

Further, on a basis of any one of the foregoing exemplary embodiments, a switch icon may be provided in a preset area surrounding each function component in the control program; and

correspondingly, after obtaining the operation of the user on the control icon and controlling, based on the operation on the control icon, the control terminal and/or the remotely controlled mobile platform to execute the control program represented by the selected function icon to implement the preset function, the method may further include:

obtaining a status switching instruction generated by triggering the switch icon corresponding to the function component by the user; and

switching a running status of the function component based on the status switching instruction.

In some exemplary embodiments, to implement fast control on the control program without modifying the control program, a switch icon may be provided in the preset area surrounding each function component in the control program, and the user may trigger the switch icon to control the running status of the function component corresponding to the switch icon. Specifically, the status switching instruction generated by triggering the switch icon corresponding to the function component by the user may be obtained; and the running status of the function component is switched based on the status switching instruction. In an actual application, if an original control program includes a visual recognition component, but the visual recognition component is not needed in a current application scenario, switching of a running status of the visual recognition component may be implemented by triggering a switch icon corresponding to the visual recognition component. In this way, one control program may be applied in a variety of scenarios, and the application rate is high.

According to the method for controlling a remotely controlled mobile platform provided in some exemplary embodiments, the status switching instruction generated by triggering the switch icon corresponding to the function component by the user is obtained; and the running status of the function component is switched based on the status switching instruction. Therefore, fast control can be implemented on the control program without modifying the control program.

Further, on a basis of any one of the foregoing exemplary embodiments, the control program may include the visual recognition component; and the controlling the control terminal and/or the remotely controlled mobile platform to execute the control program represented by the selected function icon to implement the preset function may include:

controlling, by using the visual recognition component, the control terminal and/or the remotely controlled mobile platform to recognize a character in image information captured by an image capture device to obtain a function corresponding to the image information; and

controlling the control terminal and/or the remotely controlled mobile platform to perform the function corresponding to the image information.

In some exemplary embodiments, the control program may include the visual recognition component. Specifically, after the remotely controlled mobile platform captures the image information, the control terminal and/or the remotely controlled mobile platform may be controlled, by using the visual recognition component, to recognize the character in the image information captured by the image capture device, and obtain, based on the character, the function corresponding to the image information. Further, the control terminal and/or the remotely controlled mobile platform may be controlled to perform the function corresponding to the image information.

Further, on a basis of any one of the foregoing exemplary embodiments, after the controlling the control terminal and/or the remotely controlled mobile platform to perform the function corresponding to the image information, the method may further include:

performing, based on a preset score of the function corresponding to the image information, an update operation on a score currently obtained by the remotely controlled mobile platform.

In some exemplary embodiments, the image information may correspond to a plurality of functions. For example, the function may be controlling the remotely controlled mobile platform to perform an attack in a preset direction, or may be controlling the remotely controlled mobile platform to move to a position, or may be controlling the remotely controlled mobile platform to perform an operation such as image capture. This is not limited in the present disclosure. For different functions, different scores may be assigned correspondingly in a game. Therefore, after the function corresponding to the image information is recognized and the function is performed, the score currently obtained by the remotely controlled mobile platform may be updated based on a score corresponding to an operation of performing the function.

According to the method for controlling a remotely controlled mobile platform provided in some exemplary embodiments, the control terminal and/or the remotely controlled mobile platform are/is controlled, by using the visual recognition component, to recognize the character in the image information captured by the image capture device, and obtain the function corresponding to the image information; and the control terminal and/or the remotely controlled mobile platform are/is controlled to perform the function corresponding to the image information. Therefore, diversified control can be implemented on the remotely controlled mobile platform.

For example, the image capture device of the remotely controlled mobile platform may capture the image information, and then transmits the image information to the control terminal; and the control terminal may recognize the image information, and after recognizing the character, obtains the function corresponding to the character, and displays, on the display interface of the control terminal, a prompt corresponding to the function corresponding to the character, for example, a prompt for getting bonus points and a prompt for obtaining skills. In another example, the image capture device of the remotely controlled mobile platform may capture the image information, and recognize the image information; after recognizing the character, the image capture device may obtain the function corresponding to the character, and transmit the function corresponding to the character to the control terminal; and the control terminal may display, on the display interface of the control terminal, a prompt corresponding to the function corresponding to the character, for example, a prompt for getting bonus points and a prompt for obtaining skills.

In some exemplary embodiments, the control program may include the clapping sound recognition component; and the controlling of the control terminal and/or the remotely controlled mobile platform to execute the control program represented by the selected function icon to implement the preset function may include:

controlling, by using the clapping sound recognition component, the control terminal and/or the remotely controlled mobile platform to recognize clapping sound information in a captured audio; and

controlling the control terminal and/or the remotely controlled mobile platform to perform an operation corresponding to the clapping sound information in the captured audio.

In some exemplary embodiments, the control program may include the clapping sound recognition component. Specifically, after an audio capture device disposed on the remotely controlled mobile platform captures sound information, the control terminal and/or the remotely controlled mobile platform may be controlled, by using the clapping sound recognition component, to recognize clapping sound information in a captured audio; and the control terminal and/or the remotely controlled mobile platform are/is controlled to perform an operation corresponding to the clapping sound information in the captured audio.

For example, the image capture device of the remotely controlled mobile platform may be provided with a sound capture component configured to capture sound information, and transmit the sound information to the control terminal; the control terminal recognizes the sound information, and after recognizing a clapping sound, obtains a function corresponding to the clapping sound, and displays, on the display interface of the control terminal, a prompt corresponding to the function corresponding to the clapping sound, for example, getting bonus points, obtaining skills, and following. In another example, the image capture device of the remotely controlled mobile platform captures sound information, and recognizes the sound information; after recognizing a clapping sound, the image capture device obtains a function corresponding to the clapping sound, and transmits the function corresponding to the clapping sound to the control terminal; and the control terminal displays, on the display interface of the control terminal, a prompt corresponding to the function corresponding to the clapping sound, for example, getting bonus points, obtaining skills, and following, etc. In yet another example, a sound capture device configured to capture sound may be disposed on the remotely controlled mobile platform. The sound capture device may be a microphone. This is not limited herein.

Further, on a basis of any one of the foregoing exemplary embodiments, after controlling the control terminal and/or the remotely controlled mobile platform to perform the operation corresponding to the clapping sound information in the captured audio, the method may further include:

determining a sound source location corresponding to the clapping sound information; and

controlling the remotely controlled mobile platform to obtain image information of the sound source location, and displaying the image information on the display interface.

In some exemplary embodiments, to determine a clapping sound source, after the operation corresponding to the clapping sound information is performed, the sound source location corresponding to the clapping sound information may be determined; and the remotely controlled mobile platform is controlled to obtain the image information of the sound source location and display the image information on the display interface.

According to the method for controlling a remotely controlled mobile platform provided in some exemplary embodiments, the control terminal and/or the remotely controlled mobile platform are/is controlled, by using the clapping sound recognition component, to recognize the clapping sound information in the captured audio; and the control terminal and/or the remotely controlled mobile platform are/is controlled to perform the operation corresponding to the clapping sound information in the captured audio. Therefore, diversified control can be implemented on the remotely controlled mobile platform, and fun in a game battle is further improved.

In some exemplary embodiments, the control program may include the patrol line recognition component; and the controlling of the control terminal and/or the remotely controlled mobile platform to execute the control program represented by the selected function icon to implement the preset function may include:

controlling, by using the patrol line recognition component, the control terminal and/or the remotely controlled mobile platform to recognize a patrol line in image transmission information captured by an image capture device; and

controlling the remotely controlled mobile platform to move according to the patrol line.

In some exemplary embodiments, the control program may include the patrol line recognition component. Specifically, after the remotely controlled mobile platform captures the image information, the patrol line recognition component may be used to recognize the image information to determine whether the image information includes patrol line information; and if the patrol line information exists, the remotely controlled mobile platform may be controlled to move according to the patrol line information.

Further, on a basis of any one of the foregoing exemplary embodiments, after controlling the remotely controlled mobile platform to move according to the patrol line, the method may further include:

determining time information required for completion of moving along the patrol line by the remotely controlled mobile platform; and

determining a running effect of the control program based on the time information.

In some exemplary embodiments, when the remotely controlled mobile platform moves according to the patrol line, the time information required for completion of moving along the patrol line by the remotely controlled mobile platform may be determined. It should be noted that in an actual application, a plurality of different control programs may be set, and the plurality of different control programs can implement a unified preset function(s). A running effect of each control program may be determined by comparing time information required for completion of moving along the patrol line by the remotely controlled mobile platform controlled by each control program.

In some exemplary embodiments, the control program may include both a patrol line recognition module and a visual recognition module. In the present disclosure, the module or unit may refer to a tangible mechanical and/or electrical structure designed for a specific function. In some exemplary embodiments, the module and unit may also refer to one or more computer-executable programs or one or more set of instructions stored in a storage medium configured to instruct one or more processor to execute the specific function. In an actual application, the remotely controlled mobile platform may move according to the patrol line, and during the movement, when detecting a character in the image information, may perform a function corresponding to the character.

According to the method for controlling a remotely controlled mobile platform provided in some exemplary embodiments, the control terminal and/or the remotely controlled mobile platform are/is controlled, by using the patrol line recognition component, to recognize the patrol line in the image transmission information captured by the image capture device; and the remotely controlled mobile platform is controlled to move according to the patrol line. Therefore, diversified control can be implemented on the remotely controlled mobile platform, and fun in a game battle is further improved.

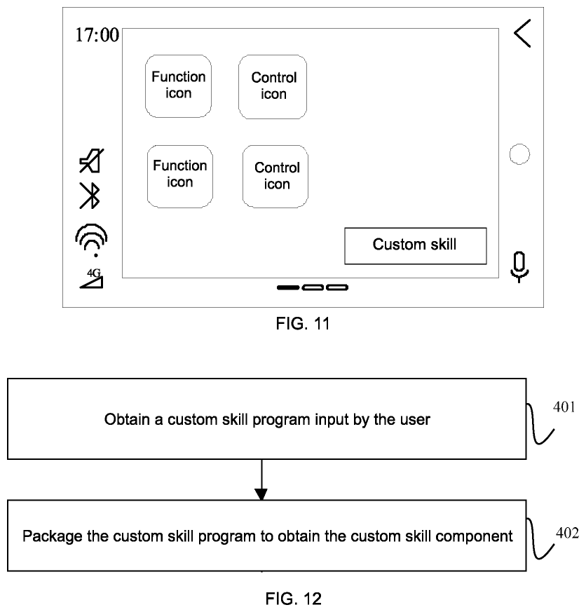

FIG. 11 is a schematic diagram of a display interface according to some exemplary embodiments of the present disclosure. On a basis of any one of the foregoing exemplary embodiments, as shown in FIG. 11, the control program represented by the function icon may further include a custom skill component; and after obtaining a selection operation of the user on the function icon, the method may further include:

displaying, in a preset position on the display interface, a custom skill icon corresponding to the custom skill component.

In some exemplary embodiments, the control program represented by the function icon may specifically further include a custom function component, where the custom function component is a function program coded by the user, and may implement a preset function. To facilitate calling the custom program by the user, the custom skill icon corresponding to the custom skill component may be displayed in the preset position on the display interface to increase the fun of game interaction.

Further, on a basis of any one of the foregoing exemplary embodiments, after displaying, in a preset position on the display interface, a custom skill icon corresponding to the custom skill component, the method may further include:

obtaining a skill release instruction triggered by triggering the custom skill icon by the user; and

controlling, based on the skill release instruction, the remotely controlled mobile platform to perform an operation corresponding to a custom skill.

In some exemplary embodiments, the user may release the custom skill by triggering the custom skill icon. Specifically, the skill release instruction triggered by triggering the custom skill icon by the user may be obtained; and based on the skill release instruction; the remotely controlled mobile platform may be controlled to perform the operation corresponding to the custom skill. For example, the custom skill may be: after being attacked, performing an attack in a direction of being attacked. Therefore, after the user triggers the skill release instruction by triggering the custom icon, when detecting that the user is attacked, the user may determine a direction of being attacked, and perform an attack in the direction. In this way, the fun of game interaction is increased, and user experience is improved.

According to the method for controlling a remotely controlled mobile platform provided in some exemplary embodiments, the custom skill icon corresponding to the custom skill component may be displayed in the preset position on the display interface. Therefore, individual requirements of the user can be satisfied, and user experience is further improved.

FIG. 12 is a schematic flowchart of a method for controlling a remotely controlled mobile platform according to some exemplary embodiments of the present disclosure. On a basis of any one of the foregoing exemplary embodiments, as shown in FIG. 12, before displaying the at least one function icon and the at least one control icon, the method may further include:

Step 401: Obtain a custom skill program input by the user.

Step 402: Package the custom skill program to obtain the custom skill component.

In some exemplary embodiments, the user may customize the control program. Specifically, the user may implement generation of the custom control program by selecting the function icon, or implement generation of the custom control program by inputting code on the programing panel. This is not limited in the present disclosure. Further, to enable the user to call the custom skill program more conveniently, the custom skill program may be packaged to obtain the custom skill component. The user may implement generation of the control program by calling the custom skill component.

According to the method for controlling a remotely controlled mobile platform provided in some exemplary embodiments, the custom skill program input by the user is obtained; and the custom skill program is packaged to obtain the custom skill component. Therefore, individual requirements of the user can be satisfied, and user experience is further improved.

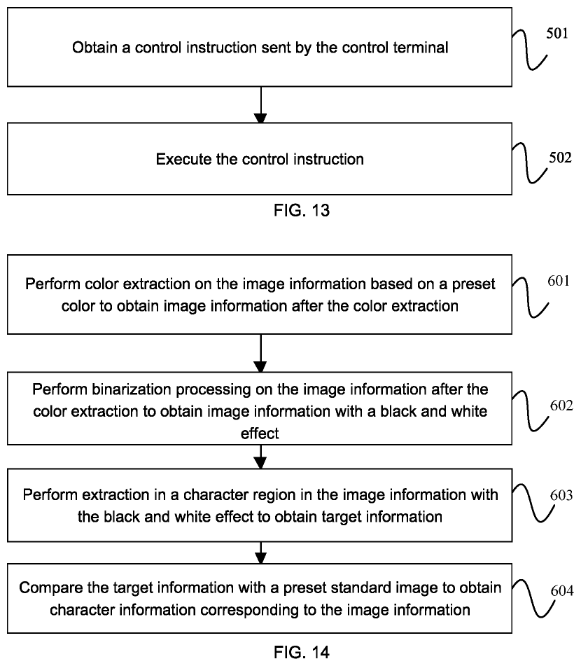

FIG. 13 is a schematic flowchart of a method for controlling a remotely controlled mobile platform according to some exemplary embodiments of the present disclosure. The method for controlling a remotely controlled mobile platform provided in some exemplary embodiments may be applied to the remotely controlled mobile platform, and the remotely controlled mobile platform is in communication with a control terminal. The method may include the following steps.

Step 501: Obtain a control instruction sent by the control terminal, where the control instruction may include a control program for controlling the control terminal and/or the mobile platform to implement a preset function, and the preset function implemented by the control program may include: controlling the remotely controlled mobile platform and/or the control terminal to recognize captured image/sound information to determine whether the image/sound information includes identification information, and if it is determined that the image/sound information includes the identification information, obtain a function corresponding to the identification information, and controlling, based on the identification information, the control terminal and/or the mobile platform to implement the function corresponding to the identification information.

Step 502: Execute the control instruction.

Some exemplary embodiments may be performed by the remotely controlled mobile platform. The remotely controlled mobile platform is in communication with the control terminal, and therefore may exchange information with the control terminal. The remotely controlled mobile platform may obtain the control instruction sent by the control terminal, where the control instruction is generated after a user triggers a control icon on a display interface of the control terminal, the control instruction may include the control program, and the control program may be generated after the user selects a function icon on the display interface of the control terminal. The control program may implement the preset function. Specifically, the preset function may include: obtaining image/sound information captured by the remotely controlled mobile platform; controlling the remotely controlled mobile platform and/or the control terminal to recognize the image/sound information to obtain a recognition result and determine whether the recognition result includes preset identification information and if it is detected that the recognition result includes the preset identification information, determine a function corresponding to the identification information; and controlling, based on the identification information, the remotely controlled mobile platform and/or the control terminal to execute the function corresponding to the identification information. Further, after obtaining the control instruction, the remotely controlled mobile platform may execute the control instruction.

According to the method for controlling a remotely controlled mobile platform provided in some exemplary embodiments, the control instruction that is sent by the control terminal and includes the control program that may implement the preset function is obtained; and the control instruction is executed. Therefore, diversity of functions performed by the remotely controlled mobile platform can be improved, and further, user experience can be improved.

Further, on a basis of any one of the foregoing exemplary embodiments, the control instruction includes a visual recognition component; and correspondingly, the executing of the control instruction may include:

obtaining image information by using a preset image capture device;

recognizing the image information to obtain a function corresponding to the image information; and

sending, to the control terminal, the function corresponding to the image information, so that the control terminal controls the remotely controlled mobile platform and/or the control terminal to perform the function.

In some exemplary embodiments, the control program may include the visual recognition component, so that the remotely controlled mobile platform may recognize the captured image information and perform the corresponding function. Specifically, when the remotely controlled mobile platform executes the control program, the image information may be obtained by using the preset image capture device; the image information is recognized to obtain the function corresponding to the image information; and the function corresponding to the image information is sent to the control terminal, so that the control terminal controls the remotely controlled mobile platform and/or the control terminal to perform the function.

It should be noted that, to control the remotely controlled mobile platform to perform more functions, a plurality of character pictures may be preset, and characters in the character pictures correspond to different functions. To enable the remotely controlled mobile platform to perform the corresponding functions based on the character pictures, a preset functional function(s) may be trained based on the characters in the character pictures to obtain a visual recognition component. Because the character pictures are light-weighted, the character pictures may be carried to any game battle scenes. Further, game battle scenes based on character recognition are also rich. Therefore, on a basis of improving diversity of battle functions, an effect of diversifying game battle scenes can be achieved, and user experience is further improved. In addition, to enable the remotely controlled mobile platform and/or the control terminal to quickly recognize the characters, the characters in the character pictures may be characters that undergo pixel art processing.

According to the method for controlling a remotely controlled mobile platform provided in some exemplary embodiments, the image information is obtained by using the preset image capture device; the image information is recognized to obtain the function corresponding to the image information; and the function corresponding to the image information is sent to the control terminal, so that the control terminal controls the remotely controlled mobile platform and/or the control terminal to perform the function. Therefore, the image information may be recognized and the corresponding function may be performed, and further, diversity of functions performed by the mobile terminal can be improved, and user experience is improved.

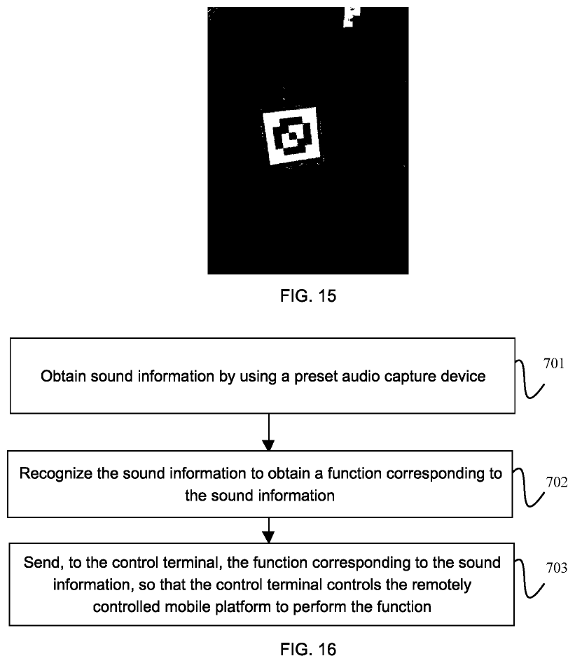

FIG. 14 is a schematic flowchart of a method for controlling a remotely controlled mobile platform according to some exemplary embodiments of the present disclosure. FIG. 15 is a diagram of extraction of a target region according to some exemplary embodiments of the present disclosure. On a basis of any one of the foregoing exemplary embodiments, the recognizing of the image information to obtain the function corresponding to the image information may include:

Step 601: Perform color extraction on the image information based on a preset color to obtain image information after the color extraction.

Step 602: Perform binarization processing on the image information after the color extraction to obtain image information with a black and white effect.

Step 603: Perform extraction in a character region in the image information with the black and white effect to obtain target information.

Step 604: Compare the target information with a preset standard image to obtain character information corresponding to the image information.

In some exemplary embodiments, after the image information captured by the image capture device on the remotely controlled mobile platform is obtained, to recognize the image information, color extraction may be performed on the image information based on the preset color first, so that the image information can be converted into a monochrome image. Further, binarization processing may be performed on the image after the color extraction to obtain the image information with the black and white effect. It should be noted that because there is relatively less data in the image information with the black and white effect, the remotely controlled mobile platform or the control terminal may extract the information in the image easily, and efficiency of recognition is improved. Further, extraction may be performed in the character region in the image information with the black and white effect to obtain the target information; and the target information may be then compared with the preset standard image to determine the character information corresponding to the image information.

Specifically, on a basis of any one of the foregoing exemplary embodiments, the performing of the color extraction on the image information based on a preset color to obtain image information after the color extraction may include:

converting an RGB model corresponding to the image information into an HSV model; and

performing color extraction on the HSV model based on the preset color to obtain the image information after the color extraction.

In some exemplary embodiments, to implement color extraction on the image information, the RGB model corresponding to the image information may be converted into the HSV model first, and color extraction may be performed on the HSV model based on the preset color to obtain the image information after the color extraction.

Specifically, on a basis of any one of the foregoing exemplary embodiments, the performing of the extraction in a character region in the image information with the black and white effect to obtain target information may include:

extracting contour information of each character in the image information with the black and white effect;

for the contour information of each character, determining whether the contour information is a quadrilateral structure; and

determining the target information based on a determining result.

In some exemplary embodiments, as shown in FIG. 15, there are two pieces of character information in total in an image, and contour information of each piece of character information in the image information is extracted. Because a preset character picture is a quadrangular picture, to implement obtaining of a character, whether the contour information is a quadrilateral may be determined for the contour information corresponding to each character. Thus, target information may be determined based on a determining result.

Specifically, on a basis of any one of the foregoing exemplary embodiments, the determining of the target information based on a determining result may include:

if the contour information is a quadrilateral structure, using the character corresponding to the contour information as the target information; or

if the contour information is not a quadrilateral structure, filtering out the character corresponding to the contour information.

In some exemplary embodiments, if the contour information of the character is a quadrilateral structure, it indicates that the contour information is image information corresponding to the preset character picture. In this case, the character corresponding to the contour information may be used as the target information. Otherwise, if the contour information is not a quadrilateral structure, it indicates that the contour information is not the image information corresponding to the preset character picture. In this case, the character corresponding to the contour information may be filtered out. As shown in FIG. 15, a character in a middle position of the image is a quadrilateral structure. Therefore, the character corresponding to the contour information may be used as the target information. In addition, a character in an upper right corner of the image is not a quadrilateral structure, and in this case, the character may be filtered out. Through selection of the target information, a region of image information that needs to be detected may be greatly reduced, and further, an amount of calculation may be reduced and efficiency of recognition is improved.

Further, on a basis of any one of the foregoing exemplary embodiments, the comparing of the target information with the preset standard image to obtain character information corresponding to the image information may include:

dividing the target information into a preset quantity of cells according to a preset division rule;

assigning a value to each of the cells according to a preset assignment method to obtain target information after assignment; and

comparing the target information after assignment with a hash table corresponding to the preset standard image to determine character information corresponding to the target information.

In some exemplary embodiments, the target information may be divided into the preset quantity of cells according to the preset division rule; values are respectively assigned to each of the cells according to the preset assignment method to obtain the target information after assignment; and the target information after assignment is compared with the hash table corresponding to the preset standard image to determine the character information corresponding to the target information. Taking an actual application as an example, the target information may be divided into 7*7 cells, and for each cell, content in the cell is determined and a value is assigned to the cell. Further, the target information may be compared with the hash table corresponding to the standard image, so that the character information corresponding to the target information may be determined.

According to the method for controlling a remotely controlled mobile platform provided in some exemplary embodiments, color extraction may be performed on the image information based on the preset color to obtain the image information after the color extraction; binarization processing may be performed on the image information after the color extraction to obtain the image information with the black and white effect; extraction may be performed in the character region in the image information with the black and white effect to obtain the target information; and the target information may be compared with the preset standard image to obtain the character information corresponding to the image information. Therefore, the character information corresponding to the image information can be determined accurately, and this may provide a basis for the remotely controlled mobile platform to perform diversified functions.

Further, on a basis of any one of the foregoing exemplary embodiments, after comparing the target information with the preset standard image to obtain character information corresponding to the image information, the method may further include:

determining a distance between the remotely controlled mobile platform and the image information and information about a location of the image information.

In some exemplary embodiments, after the function corresponding to the image information is determined based on the image information in a game battle; the function needs to be performed. For example, the function may be performing an attack in a region in which the character is located. In this case, the location of the image information needs to be determined. Specifically, the distance between the remotely controlled mobile platform and the image information and the location of the image information may be determined, and x, y, z, roll, pitch, and yaw of the image information relative to the remotely controlled mobile platform may be obtained through PNP settlement.

According to the method for controlling a remotely controlled mobile platform provided in some exemplary embodiments, the distance between the remotely controlled mobile platform and the image information and the information about the location of the image information are determined. Therefore, the remotely controlled mobile platform may be controlled to perform the corresponding operation, and diversity of the game battle is improved.

FIG. 16 is a schematic flowchart of a method for controlling a remotely controlled mobile platform according to some exemplary embodiments of the present disclosure. On a basis of any one of the foregoing exemplary embodiments, as shown in FIG. 16, the control program may include a clapping sound recognition component; and the executing of the control program may include:

Step 701: Obtain sound information by using a preset audio capture device.

Step 702: Recognize the sound information to obtain a function corresponding to the sound information.

Step 703: Send, to the control terminal, the function corresponding to the sound information, so that the control terminal controls the remotely controlled mobile platform to perform the function.

In some exemplary embodiments, the sound information may be obtained by using the preset audio capture device, and the sound information is recognized. The sound information may include clapping sound information, and different clapping sound information may correspond to different functions. The function corresponding to the sound information is determined, and the function is sent to the control terminal, so that the control terminal controls the remotely controlled mobile platform to perform the function.

According to the method for controlling a remotely controlled mobile platform provided in some exemplary embodiments, the sound information is recognized; and the function corresponding to the sound information is performed. Therefore, diversity of the game battle can be improved.

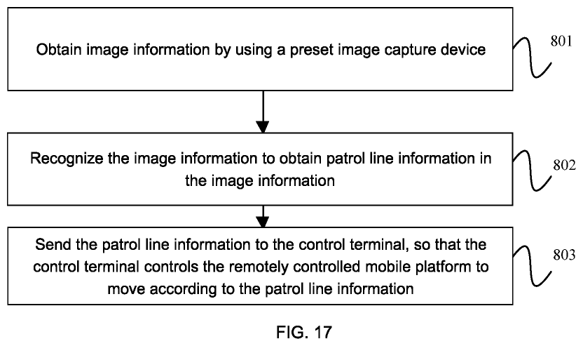

FIG. 17 is a schematic flowchart of a method for controlling a remotely controlled mobile platform according to some exemplary embodiments of the present disclosure. On a basis of any one of the foregoing exemplary embodiments, as shown in FIG. 17, the control program may include a patrol line recognition component; and the executing of the control program may include:

Step 801: Obtain image information by using a preset image capture device.

Step 802: Recognize the image information to obtain patrol line information in the image information.

Step 803: Send the patrol line information to the control terminal, so that the control terminal controls the remotely controlled mobile platform to move according to the patrol line information.

In some exemplary embodiments, the image information may be obtained by using the preset image capture device; the image information is recognized to determine whether the image information includes the patrol line information; and if the patrol line information exists, the patrol line information may be sent to the control terminal, so that the control terminal controls the remotely controlled mobile platform to move according to the patrol line.

Further, on a basis of any one of the foregoing exemplary embodiments, the recognizing of the image information to obtain patrol line information in the image information may include:

performing color extraction on the image information based on a preset color to obtain image information after the color extraction;

performing binarization processing on the image information after the color extraction to obtain image information with a black and white effect; and

performing extraction in a patrol line region in the image information with the black and white effect to obtain patrol line information.

In some exemplary embodiments, after the image information captured by the image capture device on the remotely controlled mobile platform is obtained, to recognize the patrol line information, color extraction may be performed on the image information based on the preset color first, so that the image information can be converted into a monochrome image. Further, binarization processing may be performed on the image after the color extraction to obtain the image information with the black and white effect. It should be noted that because there is relatively less data in the image information with the black and white effect, the remotely controlled mobile platform or the control terminal may extract the information in the image easily, and efficiency of recognition is improved. Further, extraction may be performed in the patrol line region in the image information with the black and white effect to obtain the patrol line information.

Further, on a basis of any one of the foregoing exemplary embodiments, the performing of the color extraction on the image information based on a preset color to obtain image information after the color extraction may include:

converting an RGB model corresponding to the image information into an HSV model; and

performing color extraction on the HSV model based on the preset color to obtain the image information after the color extraction.

In some exemplary embodiments, to implement color extraction on the image information, the RGB model corresponding to the image information may be converted into the HSV model first, and color extraction may be performed on the HSV model based on the preset color to obtain the image information after the color extraction.

Specifically, on a basis of any one of the foregoing exemplary embodiments, the performing of the extraction in a patrol line region in the image information with the black and white effect to obtain patrol line information may include:

extracting contour information of each character in the image information with the black and white effect;

for the contour information corresponding to each character, determining whether the contour information is a linear structure; and

determining the patrol line information based on a determining result.

In some exemplary embodiments, to obtain the patrol line information, the contour information of each character in the image information with the black and white effect may be extracted first. Because the patrol line information is a linear structure, whether the contour information is a linear structure is determined for the contour information corresponding to each character. Therefore, the patrol line information may be determined based on the determining result.

Specifically, on a basis of any one of the foregoing exemplary embodiments, the determining of the patrol line information based on the determining result may include:

if the contour information is a linear structure, using the character corresponding to the contour information as the patrol line information; or

if the contour information is not a linear structure, filtering out the character corresponding to the contour information.

In some exemplary embodiments, if the contour information is a linear structure, the character corresponding to the contour information may be used as the patrol line information. Correspondingly, if the contour information is not a linear structure, the character corresponding to the contour information may be filtered out, so that efficiency of recognition is improved.

Further, on a basis of any one of the foregoing exemplary embodiments, the sending of the patrol line information to the control terminal so that the control terminal controls the remotely controlled mobile platform to move according to the patrol line information may include:

determining a current moving velocity of the remotely controlled mobile platform;

determining a determination reference line based on the moving velocity; and

controlling a moving direction of the remotely controlled mobile platform, so that a midpoint of the determination reference line falls on the patrol line.

In some exemplary embodiments, after training information is obtained, the remotely controlled mobile platform needs to be controlled to move according to the patrol line information. Specifically, the current moving velocity of the remotely controlled mobile platform may be determined; the reference line may be determined based on the moving velocity; and the moving direction of the remotely controlled mobile platform may be controlled, so that the midpoint of the reference line falls on the patrol line.

Further, on a basis of any one of the foregoing exemplary embodiments, the determining of the determination reference line based on the moving velocity may include:

if the moving velocity satisfies a preset first condition, using a straight line closest to the remotely controlled mobile platform in the image information captured by the remotely controlled mobile platform as the determination reference line;

if the moving velocity satisfies a preset second condition, using a middle straight line in the image information captured by the remotely controlled mobile platform as the determination reference line; or

if the moving velocity satisfies a preset third condition, using a straight line farthest away from the remotely controlled mobile platform in the image information captured by the remotely controlled mobile platform as the determination reference line.

In some exemplary embodiments, the reference line may be determined by determining whether the moving velocity satisfies a preset condition. Specifically, if the moving velocity satisfies the preset first condition, the straight line closest to the remotely controlled mobile platform in the image information captured by the remotely controlled mobile platform may be used as the determination reference line; if the moving velocity satisfies the preset second condition, the middle straight line in the image information captured by the remotely controlled mobile platform may be used as the determination reference line; or if the moving velocity satisfies the preset third condition, the straight line farthest away from the remotely controlled mobile platform in the image information captured by the remotely controlled mobile platform may be used as the determination reference line. The preset condition may be set based on an actual requirement, and is not limited in the present disclosure.

According to the method for controlling a remotely controlled mobile platform provided in some exemplary embodiments, the image information may be obtained by using the preset image capture device; the image information may be recognized to obtain the patrol line information in the image information; and the patrol line information may be sent to the control terminal, so that the control terminal controls the remotely controlled mobile platform to move according to the patrol line information. Therefore, the remotely controlled mobile platform may be controlled to perform diversified functions, diversity of a game is improved, and user experience can be further improved.

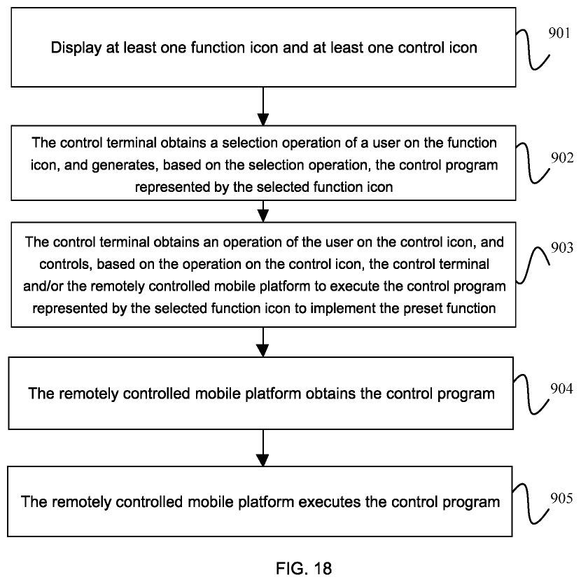

FIG. 18 is a schematic flowchart of a method for controlling a remotely controlled mobile platform according to some exemplary embodiments of the present disclosure. The method may include the following steps.

Step 901: Display at least one function icon and at least one control icon, where the function icon is used to indicate a control program for controlling a control terminal and/or a mobile platform to implement a preset function, and the control icon is used to control the control terminal and/or the remotely controlled mobile platform to execute a control program.

Step 902: The control terminal obtains a selection operation of a user on the function icon, and generates, based on the selection operation, the control program represented by the selected function icon.

Step 903: The control terminal obtains an operation of the user on the control icon, and controls, based on the operation on the control icon, the control terminal and/or the remotely controlled mobile platform to execute the control program represented by the selected function icon to implement the preset function, where the preset function that the function icon is used to implement may include: controlling the remotely controlled mobile platform and/or the control terminal to recognize captured image/sound information to determine whether the image/sound information includes identification information and if it is determined that the image/sound information includes the identification information, obtaining a function corresponding to the identification information, and controlling, based on the identification information, the control terminal and/or the mobile platform to implement the function corresponding to the identification information.

Step 904: The remotely controlled mobile platform obtains the control program.

Step 905: The remotely controlled mobile platform executes the control program.

In some exemplary embodiments, to enable the user to control the remotely controlled mobile platform, icons may be displayed on a display interface of the control terminal, where the icons may specifically include a function icon and a control icon. The function icon may be used to represent a control program for controlling the remotely controlled mobile platform to implement a preset function. There may be at least one function icon, and each function icon may represent a different function component. In addition, the control icon is provided on the display interface, and the control icon may be used to control the remotely controlled mobile platform to execute the control program identified by the function icon. Correspondingly, after the user triggers the control icon, the remotely controlled mobile platform may obtain and execute the control program. The remotely controlled mobile platform may move during execution of the control program. The remotely controlled mobile platform may further carry an image capture device, where the image capture device may perform operations such as shooting. To obtain the control program, the user may perform the selection operation on the function icon based on a current requirement, so that the control program represented by the function icon may be generated based on the selection operation. After the control program corresponding to the function icon is obtained based on the selection operation of the user, the operation of the user on the control icon may be obtained, and based on the operation of the user on the control icon, the control terminal and/or the remotely controlled mobile platform may be controlled to execute the control program represented by the selected function icon to implement the preset function. Specifically, the preset function may include: obtaining image/sound information captured by the remotely controlled mobile platform; controlling the remotely controlled mobile platform and/or the control terminal to recognize the image/sound information to obtain a recognition result and determine whether the recognition result includes preset identification information, and if it is detected that the recognition result includes the preset identification information, determining a function corresponding to the identification information; and controlling, based on the identification information, the remotely controlled mobile platform and/or the control terminal to execute the function corresponding to the identification information. It should be noted that the process of recognizing the image/sound and determining the function corresponding to the identification information may be performed by the control terminal, or may be performed by the mobile platform. Assuming that the control terminal performs the recognition operation, after obtaining the image/sound information, the remotely controlled mobile platform may transmit the image/sound information to the control terminal; and the control terminal recognizes the image/sound information according to a preset recognition method, determines whether the image/sound information includes the preset identification information, and if the preset identification information exists, may determine the function corresponding to the identification information, and control the remotely controlled mobile platform to perform the function. Assuming that the remotely controlled mobile platform performs the recognition operation, after obtaining the image/sound information, the remotely controlled mobile platform may recognize the image/sound information to determine whether the image/sound information includes the preset identification information, and if the preset identification information exists, may determine the function corresponding to the identification information, and send, to the control terminal, the function corresponding to the identification information, so that the control terminal may control the remotely controlled mobile platform to perform the function. Correspondingly, the remotely controlled mobile platform may obtain a control instruction, and execute the control instruction.

According to the method for controlling a remotely controlled mobile platform provided in some exemplary embodiments, the at least one function icon and at least one control icon are displayed, where the function icon may be used to represent the control program for controlling the control terminal and/or the mobile platform to implement the preset function, and the control icon may be used to control the control terminal and/or the remotely controlled mobile platform to execute the control program; the control terminal may obtain the selection operation of the user on the function icon, and generate, based on the selection operation, the control program represented by the selected function icon; the control terminal may obtain the operation of the user on the control icon, and control, based on the operation on the control icon, the control terminal and/or the remotely controlled mobile platform to execute the control program represented by the selected function icon to implement the preset function, where the preset function that the function icon is used to implement may include: controlling the remotely controlled mobile platform and/or the control terminal to recognize the captured image/sound information to determine whether the image/sound information includes the identification information, and if it is determined that the image/sound information includes the identification information, obtaining the function corresponding to the identification information, and controlling, based on the identification information, the control terminal and/or the mobile platform to implement the function corresponding to the identification information; the remotely controlled mobile platform obtains the control program; and the remotely controlled mobile platform executes the control program. In this way, diversified control can be implemented on the remotely controlled mobile platform, and further, the user's game experience can be improved.

FIG. 19 is a schematic structural diagram of a control terminal according to some exemplary embodiments of the present disclosure. The control terminal may be configured to establish a communication with a remotely controlled mobile platform. The control terminal may include one or more processors 111 working separately or jointly. The control terminal may further include one or more storage medium storing a set of instructions for controlling a remotely controlled mobile platform; the one or more processor is in communication with the one or more storage medium; during operation, the one or more processor may be configured to perform the following operations:

displaying at least one function icon and at least one control icon, where the at least one function icon is used to represent a control program for controlling the control terminal and/or the mobile platform to implement a preset function, and the at least one control icon is used to control the control terminal and/or the remotely controlled mobile platform to execute the control program;

obtaining a selection operation of a user on the function icon, and generating, based on the selection operation, the control program represented by the selected function icon; and

obtaining an operation of the user on the control icon, and controlling, based on the operation on the control icon, the control terminal and/or the remotely controlled mobile platform to execute the control program represented by the selected function icon to implement the preset function, where

the preset function that the function icon is used to implement includes: controlling the remotely controlled mobile platform and/or the control terminal to recognize captured image/sound information to determine whether the image/sound information includes identification information, and if it is determined that the image/sound information includes the identification information, obtaining a function corresponding to the identification information, and controlling, based on the identification information, the control terminal and/or the mobile platform to implement the function corresponding to the identification information.

Further, on a basis of any one of the foregoing exemplary embodiments, the identification information includes at least one of the following: a clap, a patrol line marker, or a picture marker.

Further, on a basis of any one of the foregoing exemplary embodiments, when recognizing the captured image/sound information to determine whether the image/sound information includes identification information, the processor may be configured to:

process the captured image/sound information to generate processed information, and determine, based on the processed information, whether the image/sound information includes the identification information.

Further, on a basis of any one of the foregoing exemplary embodiments, when recognizing the captured image/sound information to determine whether the image/sound information includes identification information, the processor may be configured to:

control a hardware device disposed on the remotely controlled mobile platform to process the image/sound information to generate the processed information, and determine, based on the processed information, whether the image/sound information includes the identification information; or

control the control terminal to obtain the captured image/sound information, process the image/sound information to generate the processed information, and determine, based on the processed information, whether the image/sound information includes the identification information.

Further, on a basis of any one of the foregoing exemplary embodiments, the control program represented by the function icon includes a function component, where the function component includes at least one of the following: a visual recognition component, a clapping sound recognition component, or a patrol line recognition component.

Further, on a basis of any one of the foregoing exemplary embodiments, prior to displaying the at least one function icon and at least one control icon, the processor may be further configured to:

obtain a call request of the user to a preset functional function, where the call request includes a function identifier of the functional function;

provide the functional function corresponding to the function identifier for the user based on the call request;

obtain a training operation of the user on the functional function, and obtain a trained functional function; and

package the trained functional function to obtain the function component.

Further, on a basis of any one of the foregoing exemplary embodiments, when obtaining the training operation of the user on the functional function, and obtaining the trained functional function, the processor may be configured to:

obtain preset first training data, where the first training data includes audio data of different quantities of claps in different scenarios; and

train the functional function by using the first training data to obtain a trained clapping sound recognition function; and

correspondingly, when packaging the trained functional function to obtain the function component, the processor may be configured to:

package the trained clapping sound recognition function to obtain the clapping sound recognition component.

Further, on a basis of any one of the foregoing exemplary embodiments, when obtaining the training operation of the user on the functional function and obtaining the trained functional function, the processor may be configured to:

obtain preset second training data, where the second training data includes at least one of the following: a character and image data, and the character includes a letter, a number, and a special symbol; and

train the functional function by using the second training data to obtain a trained visual recognition function; and

correspondingly, when packaging the trained functional function to obtain the function component, the processor may be configured to:

package the trained visual recognition function to obtain the visual recognition component.

Further, on a basis of any one of the foregoing exemplary embodiments, when training the functional function by using the second training data to obtain the trained visual recognition function, the processor may be configured to:

store the second training data as a standard image to obtain the trained visual recognition function.

Further, on a basis of any one of the foregoing exemplary embodiments, when obtaining the training operation of the user on the functional function and obtaining the trained functional function, the processor may be configured to:

obtain preset third training data, where the third training data includes patrol line image data, and the remotely controlled mobile platform may move according to the patrol line; and

train the trained visual recognition function by using the third training data to obtain a trained patrol line recognition function; and

correspondingly, when packaging the trained functional function to obtain the function component, the processor may be configured to:

package the trained patrol line recognition function to obtain the patrol line recognition component.

Further, on a basis of any one of the foregoing exemplary embodiments, prior to displaying the at least one function icon and at least one control icon, the processor may be further configured to:

display at least one function category icon;

obtain a trigger operation of the user on the function category icon; and

display the at least one function icon based on the trigger operation.

Further, on a basis of any one of the foregoing exemplary embodiments, when obtaining the selection operation of the user on the function icon, and generating, based on the selection operation, the control program represented by the selected function icon, the processor may be configured to:

obtain at least one selection operation of the user on the function icon; and

generate the control program according to order of the selection operation.

Further, on a basis of any one of the foregoing exemplary embodiments, when obtaining the operation of the user on the control icon, and controlling, based on the operation on the control icon, the control terminal and/or the remotely controlled mobile platform to execute the control program represented by the selected function icon to implement the preset function, the processor may be configured to:

obtain the operation of the user on the control icon; and

control, based on the operation of the user on the control icon, the control terminal and/or the remotely controlled mobile platform to execute, according to order of the function components in the control program represented by the function icon, the control program represented by the selected function icon to implement the preset function.

Further, on a basis of any one of the foregoing exemplary embodiments, the control icon includes a run icon; and when obtaining the operation of the user on the control icon, and controlling, based on the operation on the control icon, the control terminal and/or the remotely controlled mobile platform to execute the control program represented by the selected function icon to implement the preset function, the processor may be configured to:

obtain a run instruction generated by triggering the run icon by the user; and

control, based on the run instruction, the control terminal and/or the remotely controlled mobile platform to execute the control program represented by the selected function icon to implement the preset function.

Further, on a basis of any one of the foregoing exemplary embodiments, after obtaining the run instruction generated by triggering the run icon by the user, the processor may be further configured to:

switch a running status of the run icon based on the trigger, where the running status includes a running state and a stopping state.

Further, on a basis of any one of the foregoing exemplary embodiments, the control icon includes a stop icon; and after obtaining the operation of the user on the control icon, and controlling, based on the operation on the control icon, the control terminal and/or the remotely controlled mobile platform to execute the control program represented by the selected function icon to implement the preset function, the processor may be further configured to:

obtain a stop instruction generated by triggering the stop icon by the user; and

control, based on the stop instruction, the control terminal and/or the remotely controlled mobile platform to stop executing the control program.

Further, on a basis of any one of the foregoing exemplary embodiments, the stop icon includes a preset return icon and the run icon in the stopping state.

Further, on a basis of any one of the foregoing exemplary embodiments, the control icon includes an image-transmission-information-display icon; and after obtaining the operation of the user on the control icon, controlling, based on the operation on the control icon, the control terminal and/or the remotely controlled mobile platform to execute the control program represented by the selected function icon to implement the preset function, the processor may be further configured to:

obtain an image-transmission-information-display instruction generated by triggering the image-transmission-information-display icon by the user; and

obtain, based on the image-transmission-information-display instruction, image transmission information captured by an image capture device disposed on the remotely controlled mobile platform, and display the image transmission information.

Further, on a basis of any one of the foregoing exemplary embodiments, the control icon further includes a programming-mode-switching icon; and the processor may be further configured to:

obtain a programming-mode-switching instruction generated by triggering the programming-mode-switching icon by the user; and

call a preset programming panel based on the programming-mode-switching instruction, so that the user may edit code on the programming panel to generate the control program.

Further, on a basis of any one of the foregoing exemplary embodiments, the control icon includes a communication icon; and before obtaining the operation of the user on the control icon and controlling, based on the operation on the control icon, the control terminal and/or the remotely controlled mobile platform to execute the control program represented by the selected function icon to implement the preset function, the processor may be further configured to:

obtain a connection instruction generated by triggering the communication icon by the user; and

establish a communication with the remotely controlled mobile platform in a preset connection mode based on the connection instruction.

Further, on a basis of any one of the foregoing exemplary embodiments, after establishing the communication with the remotely controlled mobile platform in the preset connection mode based on the connection instruction, the processor may be further configured to:

switch the communication icon to a remotely controlled mobile platform status icon.

Further, on a basis of any one of the foregoing exemplary embodiments, after obtaining the selection operation of the user on the function icon, and generating, based on the selection operation, the control program represented by the selected function icon, the processor may be further configured to:

obtain a removal operation of the user on a function component in the control program; and

move, based on the removal operation, the function component selected by the user to a preset area.

Further, on a basis of any one of the foregoing exemplary embodiments, when obtaining the removal operation of the user on the control program, the processor may be configured to:

obtain the removal operation performed by the user on the function component by pressing and holding, and/or double-clicking, and/or dragging.

Further, on a basis of any one of the foregoing exemplary embodiments, a switch icon is provided in a preset area surrounding each function component in the control program; and

correspondingly, after obtaining the operation of the user on the control icon, and controlling, based on the operation on the control icon, the control terminal and/or the remotely controlled mobile platform to execute the control program represented by the selected function icon to implement the preset function, the processor may be further configured to:

obtain a status switching instruction generated by triggering the switch icon corresponding to the function component by the user; and

switch a running status of the function component based on the status switching instruction.

Further, on a basis of any one of the foregoing exemplary embodiments, the control program includes the visual recognition component; and when controlling the control terminal and/or the remotely controlled mobile platform to execute the control program represented by the selected function icon to implement the preset function, the processor may be configured to:

control, by using the visual recognition component, the control terminal and/or the remotely controlled mobile platform to recognize a character in image information captured by an image capture device to obtain a function corresponding to the image information; and

control the control terminal and/or the remotely controlled mobile platform to perform the function corresponding to the image information.

Further, on a basis of any one of the foregoing exemplary embodiments, after controlling the control terminal and/or the remotely controlled mobile platform to perform the function corresponding to the image information, the processor may be further configured to:

perform, based on a preset score of the function corresponding to the image information, an update operation on a score currently obtained by the remotely controlled mobile platform.

Further, on a basis of any one of the foregoing exemplary embodiments, the control program includes the clapping sound recognition component; and when controlling the control terminal and/or the remotely controlled mobile platform to execute the control program represented by the selected function icon to implement the preset function, the processor may be configured to:

control, by using the clapping sound recognition component, the control terminal and/or the remotely controlled mobile platform to recognize clapping sound information in a captured audio; and

control the control terminal and/or the remotely controlled mobile platform to perform an operation corresponding to the clapping sound information in the captured audio.

Further, on a basis of any one of the foregoing exemplary embodiments, after controlling the control terminal and/or the remotely controlled mobile platform to perform the operation corresponding to the clapping sound information in the captured audio, the processor may be further configured to:

determine a sound source location corresponding to the clapping sound information; and

control the remotely controlled mobile platform to obtain image information of the sound source location, and display the image information on the display interface.

Further, on a basis of any one of the foregoing exemplary embodiments, the control program includes the patrol line recognition component; and when controlling the control terminal and/or the remotely controlled mobile platform to execute the control program represented by the selected function icon to implement the preset function, the processor may be configured to:

control, by using the patrol line recognition component, the control terminal and/or the remotely controlled mobile platform to recognize a patrol line in image transmission information captured by an image capture device; and

control the remotely controlled mobile platform to move according to the patrol line.

Further, on a basis of any one of the foregoing exemplary embodiments, after controlling the remotely controlled mobile platform to move according to the patrol line, the processor may be further configured to:

determine time information required for completion of moving along the patrol line by the remotely controlled mobile platform; and

determine a running effect of the control program based on the time information.

Further, on a basis of any one of the foregoing exemplary embodiments, the control program represented by the function icon further includes a custom skill component; and after obtaining the selection operation of the user on the function icon, the processor may be further configured to:

display, in a preset position on the display interface, a custom skill icon corresponding to the custom skill component.

Further, on a basis of any one of the foregoing exemplary embodiments, after displaying, in the preset position of the display interface, the custom skill icon corresponding to the custom skill component, the processor may be further configured to:

obtain a skill release instruction triggered by triggering the custom skill icon by the user; and

control, based on the skill release instruction, the remotely controlled mobile platform to perform an operation corresponding to the custom skill.

Further, on a basis of any one of the foregoing exemplary embodiments, prior to displaying the at least one function icon and at least one control icon, the processor may be further configured to:

obtain a custom skill program input by the user; and

package the custom skill program to obtain the custom skill component.

FIG. 20 is a schematic structural diagram of a remotely controlled mobile platform according to some exemplary embodiments of the present disclosure. The remotely controlled mobile platform is in communication with a control terminal. As shown in FIG. 20, the remotely controlled mobile platform includes one or more processors 121 working separately or jointly. The remotely controlled mobile platform may further include one or more storage medium storing a set of instructions for operation; the one or more processor is in communication with the one or more storage medium; during the operation, the one or more processor may be configured to perform the following operations:

obtaining a control instruction sent by the control terminal, where the control instruction includes a control program for controlling the control terminal and/or the mobile platform to implement a preset function, and the preset function implemented by the control program includes: controlling the remotely controlled mobile platform and/or the control terminal to recognize captured image/sound information to determine whether the image/sound information includes identification information, and if it is determined that the image/sound information includes the identification information, obtaining a function corresponding to the identification information, and controlling, based on the identification information, the control terminal and/or the mobile platform to implement the function corresponding to the identification information; and

executing the control instruction.

Further, on a basis of any one of the foregoing exemplary embodiments, the control instruction includes a visual recognition component; and correspondingly, when executing the control instruction, the processor may be configured to:

obtain image information by using a preset image capture device;

recognize the image information to obtain a function corresponding to the image information; and

send, to the control terminal, the function corresponding to the image information, so that the control terminal controls the remotely controlled mobile platform and/or the control terminal to perform the function.

Further, on a basis of any one of the foregoing exemplary embodiments, when recognizing the image information to obtain the function corresponding to the image information, the processor may be configured to:

perform color extraction on the image information based on a preset color to obtain image information after the color extraction;

perform binarization processing on the image information after the color extraction, to obtain image information with a black and white effect; and

perform extraction in a character region in the image information with the black and white effect to obtain target information; and

compare the target information with a preset standard image to obtain character information corresponding to the image information.

Further, on a basis of any one of the foregoing exemplary embodiments, when performing color extraction on the image information based on the preset color to obtain the image information after the color extraction, the processor may be configured to:

convert an RGB model corresponding to the image information into an HSV model; and

perform color extraction on the HSV model based on the preset color to obtain the image information after the color extraction.

Further, on a basis of any one of the foregoing exemplary embodiments, when performing extraction in the character region in the image information with the black and white effect to obtain the target information, the processor may be configured to:

extract contour information of each character in the image information with the black and white effect;

for the contour information corresponding to each character, determine whether the contour information is a quadrilateral structure; and

determine the target information based on a determining result.

Further, on a basis of any one of the foregoing exemplary embodiments, when determining the target information based on the determining result, the processor may be configured to:

if the contour information is a quadrilateral structure, use the character corresponding to the contour information as the target information; or

if the contour information is not a quadrilateral structure, filter out the character corresponding to the contour information.

Further, on a basis of any one of the foregoing exemplary embodiments, when comparing the target information with the preset standard image to obtain the character information corresponding to the image information, the processor may be configured to:

divide the target information into a preset quantity of cells according to a preset division rule;

assign a value to each of the cells according to a preset assignment method to obtain target information after assignment; and

compare the target information after assignment with a hash table corresponding to the preset standard image to determine character information corresponding to the target information.

Further, on a basis of any one of the foregoing exemplary embodiments, after comparing the target information with the preset standard image to obtain the character information corresponding to the image information, the processor may be further configured to:

determine a distance between the remotely controlled mobile platform and the image information and information about a location of the image information.

Further, on a basis of any one of the foregoing exemplary embodiments, the control program includes a clapping sound recognition component; and when executing the control program, the processor may be configured to:

obtain sound information by using a preset audio capture device;

recognize the sound information to obtain a function corresponding to the sound information; and

send, to the control terminal, the function corresponding to the sound information, so that the control terminal controls the remotely controlled mobile platform to perform the function.

Further, on a basis of any one of the foregoing exemplary embodiments, the control program includes a patrol line recognition component; and when executing the control program, the processor may be configured to:

obtain image information by using a preset image capture device;

recognize the image information to obtain patrol line information in the image information; and

send the patrol line information to the control terminal, so that the control terminal controls the remotely controlled mobile platform to move according to the patrol line information.

Further, on a basis of any one of the foregoing exemplary embodiments, when recognizing the image information to obtain the patrol line information in the image information, the processor may be configured to:

perform color extraction on the image information based on a preset color to obtain image information after the color extraction;

perform binarization processing on the image information after the color extraction to obtain image information with a black and white effect; and

perform extraction in a patrol line region in the image information with the black and white effect to obtain patrol line information.

Further, on a basis of any one of the foregoing exemplary embodiments, when performing color extraction on the image information based on the preset color to obtain the image information after the color extraction, the processor may be configured to:

convert an RGB model corresponding to the image information into an HSV model; and

perform color extraction on the HSV model based on the preset color to obtain the image information after the color extraction.

Further, on a basis of any one of the foregoing exemplary embodiments, when performing extraction in the patrol line region in the image information with the black and white effect to obtain the patrol line information, the processor may be configured to:

extract contour information of each character in the image information with the black and white effect;

for the contour information corresponding to each character, determine whether the contour information is a linear structure; and

determine the patrol line information based on a determining result.

Further, on a basis of any one of the foregoing exemplary embodiments, when determining the patrol line information based on the determining result, the processor may be configured to:

if the contour information is a linear structure, use the character corresponding to the contour information as the patrol line information; or

if the contour information is not a linear structure, filter out the character corresponding to the contour information.

Further, on a basis of any one of the foregoing exemplary embodiments, when sending the patrol line information to the control terminal so that the control terminal controls the remotely controlled mobile platform to move according to the patrol line information, the processor may be configured to:

determine a current moving velocity of the remotely controlled mobile platform;

determine a determination reference line based on the moving velocity; and

control a moving direction of the remotely controlled mobile platform, so that a midpoint of the determination reference line falls on the patrol line.

Further, on a basis of any one of the foregoing exemplary embodiments, when determining the determination reference line based on the moving velocity, the processor may be configured to:

if the moving velocity satisfies a preset first condition, use a straight line closest to the remotely controlled mobile platform in the image information captured by the remotely controlled mobile platform as the determination reference line;

if the moving velocity satisfies a preset second condition, use a middle straight line in the image information captured by the remotely controlled mobile platform as the determination reference line; or

if the moving velocity satisfies a preset third condition, use a straight line farthest away from the remotely controlled mobile platform in the image information captured by the remotely controlled mobile platform as the determination reference line.

Some exemplary embodiments of the present disclosure provide a system for controlling a remotely controlled mobile platform, including:

at least one function icon and at least one control icon are displayed on a display interface of the control terminal, where the function icon is used to represent a control program for controlling the control terminal and/or the mobile platform to implement a preset function, and the control icon is used to control the control terminal and/or the remotely controlled mobile platform to execute the control program;

the control terminal obtains a selection operation of a user on the function icon, and generates, based on the selection operation, the control program represented by the selected function icon;

the control terminal obtains an operation of the user on the control icon, and controls, based on the operation on the control icon, the control terminal and/or the remotely controlled mobile platform to execute the control program represented by the selected function icon, to implement the preset function, where the preset function that the function icon is used to implement includes: controlling the remotely controlled mobile platform and/or the control terminal to recognize captured image/sound information to determine whether the image/sound information includes identification information, and if it is determined that the image/sound information includes the identification information, obtaining a function corresponding to the identification information, and controlling, based on the identification information, the control terminal and/or the mobile platform to implement the function corresponding to the identification information;

the remotely controlled mobile platform obtains the control program; and

the remotely controlled mobile platform executes the control program.

In addition, some exemplary embodiments further provide a computer-readable storage medium (e.g., a non-transitory computer-readable storage medium), where the computer-readable storage medium stores a computer program (a set of instructions), and when the computer program is executed by a processor, the method in the foregoing exemplary embodiments is implemented.

It should be understood that in the exemplary embodiments provided in the present disclosure, the disclosed apparatus and method may be implemented in other manners. The described apparatus embodiments are merely exemplary. For example, the unit division is merely logical function division and there may be other divisions in actual implementation. For example, a plurality of units or components may be combined or integrated into a system, or some features may be omitted, or may not be performed. In addition, the displayed or discussed mutual couplings or direct couplings or communications may be implemented by using some interfaces. The indirect couplings or communications between the apparatuses or units may be implemented in electronic, mechanical, or other forms.

The units described herein as separate parts may or may not be physically separate, and parts displayed as units may or may not be physical units, may be located in one position, or may be distributed on a plurality of network elements. Some or all of the units may be selected based on actual requirements to achieve the objects of the solutions of some exemplary embodiments.

In addition, functional units in some exemplary embodiments of the present disclosure may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, a network device, or the like) or a processor to perform a part of the steps of the methods described in some exemplary embodiments of the present disclosure. The foregoing storage medium may include: any medium that can store program code, such as a USB flash drive, a removable hard disk, a read-only memory (ROM), a random access memory (RAM), a magnetic disk, or an optical disc.

It may be understood by persons skilled in the art that, for the purpose of convenient and brief description, division of the foregoing functional modules is used as an example for illustration. In actual application, the foregoing functions can be allocated to different functional modules and implemented according to a requirement, that is, an internal structure of the apparatus is divided into different functional modules to implement all or a part of the functions described above. For a detailed working process of the foregoing apparatus, reference may be made to a corresponding process in the foregoing exemplary method embodiments, and details will not be described again herein.

Finally, it should be noted that the foregoing exemplary embodiments are merely intended for describing the technical solutions of the present disclosure, but not for limiting the present disclosure. Although the present disclosure is described in detail with reference to the foregoing exemplary embodiments, persons of ordinary skill in the art should understand that they may still make modifications to the technical solutions described in the foregoing exemplary embodiments or make equivalent replacements to some or all technical features thereof, without departing from the scope of the technical solutions of some exemplary embodiments of the present disclosure.

What is claimed is:

1. A method for controlling a remotely controlled mobile platform, comprising:
displaying at least one function icon, the at least one function icon being associated with at least one corresponding control program configured to control a target device to implement at least one preset function;
displaying at least one control icon, the at least one icon being configured to control the target device to execute the at least one control program, wherein the target device includes at least one of the remotely controlled mobile platform or a control terminal in communication with the remotely controlled mobile platform;
obtaining, from a user, a selection operation to a selected function icon of the at least one function icon;
generating, based on the selection operation, the corresponding control program associated with the selected function icon;
obtaining an operation from the user to an operated control icon of the at least one control icon; and
controlling, based on the operation on the operated control icon, the target device to execute the control program associated with the selected function icon to implement the corresponding preset function,
wherein the preset function includes controlling the target device to perform:
recognizing and determining that the captured information includes identification information, wherein the captured information includes at least one of captured image information or captured sound information,
obtaining a function corresponding to the identification information, and
controlling, based on the identification information, the target device to implement the function corresponding to the identification information.

2. The method according to claim 1, wherein the identification information includes at least one of a clapping sound, a patrol line marker, or a picture marker.

3. The method according to claim 1, wherein the recognizing and determining that the captured information includes identification information includes:
processing the captured information to generate processed information; and
determining, based on the processed information, whether the captured information includes the identification information.

4. The method according to claim 3, wherein the recognizing and determining that the captured information includes identification information further includes:
controlling a hardware device of the remotely controlled mobile platform to process the captured information to generate the processed information, and determining, based on the processed information, whether the captured information includes the identification information; or
controlling the control terminal to obtain the captured information, processing the captured information to generate the processed information, and determining, based on the processed information, whether the captured information includes the identification information.

5. The method according to claim 1, wherein
the control program associated with the selected function icon includes a function component associated with a function component icon, and
the function component includes at least one of a visual recognition component, a clapping sound recognition component, or a patrol line recognition component.

6. The method according to claim 1, further comprising, prior to the displaying of the at least one function icon and the at least one control icon:
obtaining, from the user, a call request including a function identifier corresponding to a preset functional function;
providing, to the user, the preset functional function based on the call request;
obtaining, from the user, a training operation on the preset functional function to obtain a trained functional function; and
packaging the trained functional function to obtain the function component.

7. The method according to claim 1, further comprising, prior to the displaying of the at least one function icon and the at least one control icon:
displaying at least one function category icon;
obtaining, from the user, a trigger operation to the function category icon; and
displaying the at least one function icon based on the trigger operation.

8. The method according to claim 1, wherein the obtaining of the selection operation to the selected function icon and the generating, based on the selection operation, of the corresponding control program associated with the selected function icon include:
obtaining, from the user and in an order, at least one selection operation to the function icon; and
generating the corresponding control program based on the order of the at least one selection operation.

9. The method according to claim 1, wherein
the at least one control icon further includes a run icon; and
the obtaining of the operation from the user to the operated control icon and the controlling of the target device to execute the control program associated with the selected function icon includes:
obtaining, from the user, a run instruction generated by triggering the run icon, and
controlling, based on the run instruction, the target device to execute the control program associated with the selected function icon to implement the corresponding preset function.

10. The method according to claim 1, wherein
the at least one control icon further includes a stop icon; and
after the obtaining of the operation from the user to the operated control icon and the controlling, based on the operation on the operated control icon, of the target device to execute the control program associated with the selected function icon, the method further comprises:
obtaining a stop instruction generated by triggering the stop icon by the user, and
controlling, based on the stop instruction, the target device to stop executing the corresponding control program.

11. The method according to claim 1, wherein
the at least one control icon further includes an image-transmission-information-display icon; and
after the obtaining of the operation from the user to the operated control icon and the controlling, based on the operation on the operated control icon, of the target device to execute the control program associated with the selected function icon, the method further comprises:
obtaining an image-transmission-information-display instruction generated by triggering the image-transmission-information-display icon by the user, and
obtaining, based on the image-transmission-information-display instruction, image transmission information captured by an image capture device disposed on the remotely controlled mobile platform, and
displaying the image transmission information.

12. The method according to claim 1, wherein
the at least one control icon further includes a programming-mode-switching icon; and
the method further comprises:
obtaining a programming-mode-switching instruction generated by triggering the programming-mode-switching icon by the user, and
call a preset programming panel based on the programming-mode-switching instruction to allow editing a code on the programming panel to generate the control program.

13. The method according to claim 1, further comprising, after the obtaining of the selection operation to the selected function icon and the generating, based on the selection operation, of the corresponding control program associated with the selected function icon:
obtaining, from the user, a removal operation on a function component associated with a function component icon in the control program; and
moving, based on the removal operation, the function component icon to a first preset area.

14. The method according to claim 13, wherein the obtaining of the removal operation on the function component in the control program includes:
obtaining the removal operation performed by the user to the function component icon by at least one of pressing and holding, double-clicking, or dragging.

15. The method according to claim 1, wherein
a switch icon is disposed in a second preset area surrounding a function component icon associated with a function component in the control program; and
after the obtaining of the operation to the operated control icon and the controlling, based on the operation on the operated control icon, of the target device to execute the control program associated with the selected function icon, the method further comprises:
obtaining a status switching instruction generated by triggering the switch icon by the user; and
switching a running status of the function component based on the status switching instruction.

16. The method according to claim 5, wherein
the at least one control program includes the visual recognition component; and
the controlling of the target device to execute the control program associated with the selected function icon to implement the preset function includes:
controlling, by using the visual recognition component, the target device to recognize a character in the captured image information to obtain a function corresponding to the captured image information; and
controlling the target device to perform the function corresponding to the captured image information.

17. The method according to claim 16, further comprising, after the controlling of the target device to perform the function corresponding to the captured image information:
performing, based on a preset score of the function corresponding to the captured image information, an update operation on a current score of the remotely controlled mobile platform.

18. The method according to claim 5, wherein the control program includes the clapping sound recognition component; and
the controlling of the target device to execute the control program associated with the selected function icon to implement the preset function include:
controlling, by using the clapping sound recognition component, the target device to recognize the captured clapping sound information in a captured audio; and
controlling the target device to perform an operation corresponding to the captured clapping sound information in the captured audio.

19. A method for controlling a remotely controlled mobile platform, comprising:
obtaining a control instruction sent by a control terminal in communication with the remotely controlled mobile platform, wherein the control instruction includes a control program for controlling the target device in communication with the remotely controlled mobile platform to implement a preset function that includes:
controlling the target device to perform:
recognizing and determining that the captured information includes identification information, wherein the captured information includes at least one of captured image information or captured sound information,
obtaining a function corresponding to the identification information, and
controlling, based on the identification information, the target device to implement the function corresponding to the identification information; and
executing the control instruction.

20. A remotely controlled mobile platform, comprising:
at least one storage medium storing a set of instructions for controlling the remotely controlled mobile platform; and
at least one processor in communication with the at least one storage medium, wherein during operation, the at least one processor executes the set of instructions to:
obtain a control instruction sent by a control terminal in communication with the remotely controlled mobile platform, wherein the control instruction includes a control program for controlling the target device in communication with the remotely controlled mobile platform to implement a preset function that includes:
controlling the target device to perform:
recognizing and determining that the captured information includes identification information, wherein the captured information includes at least one of captured image information or captured sound information,
obtaining a function corresponding to the identification information, and
controlling, based on the identification information, the target device to implement the function corresponding to the identification information; and
executing the control instruction.
